(19) United States
(12) Patent Application Publication
(10) Pub. No.: US 2024/0246070 A1
(43) Pub. Date: Jul. 25, 2024

(54) PIPERIDINIUM-CONTAINING ANION EXCHANGE POLYMERS

(71) Applicant: Versogen, Inc., Newark, DE (US)

(72) Inventors: Junhua Wang, Newark, DE (US); Keda Hu, Newark, DE (US); Lan Wang, Newark, DE (US); Yushan Yan, Hockessin, DE (US)

(21) Appl. No.: 18/389,737

(22) Filed: Dec. 19, 2023

Related U.S. Application Data
(60) Provisional application No. 63/433,745, filed on Dec. 19, 2022.

(51) Int. Cl. B01J 41/13; C08G 73/06; H01M 4/88; H01M 4/94

(52) U.S. Cl. CPC B01J 41/13; C08G 73/0627; H01M 4/881; H01M 4/94

(57) ABSTRACT

Poly(aryl alkylene) polymers with pendant piperidinium-functionalized groups are provided which have an alkaline-stable cation, such as imidazolium, introduced into a rigid aromatic polymer backbone free of ether bonds. Hydroxide exchange membranes or hydroxide exchange ionomers formed from these polymers exhibit superior chemical stability, hydroxide conductivity, decreased water uptake, good solubility in selected solvents, and improved mechanical properties in an ambient dry state as compared to conventional hydroxide exchange membranes or ionomers. Hydroxide exchange membrane fuel cells and hydroxide exchange membrane electrolyzers comprising the poly(aryl alkylene) polymers with pendant piperidinium-functionalized groups exhibit enhanced performance and durability at relatively high temperatures.

### CROSS REFERENCE TO RELATED APPLICATIONS

This application claims benefit of U.S. Provisional Application No. 63/433,745 filed Dec. 19, 2022, the entire disclosure of which is herein incorporated by reference.

### FIELD OF THE INVENTION

Anion exchange polymers capable of forming anion-exchange membranes (AEMs) and ionomers (AEIs) are provided for use in anion exchange membrane devices including fuel cells (FCs), electrolyzers (ELs) and electrodialyzer. More specifically, hydroxide exchange polymers are provided which are capable of forming hydroxide-exchange membranes (HEMs), and ionomers (HEIs) for use in various applications such as hydroxide exchange membrane fuel cells (HEMFCs) and hydroxide exchange membrane electrolyzers (HEMELs).

### BACKGROUND OF THE INVENTION

Proton exchange membrane fuel cells (PEMFCs) are considered to be clean and efficient power sources. Steele et al., Nature 2001, 414, 345. However, the high cost and unsatisfactory durability of catalysts are major barriers for large-scale commercialization of PEMFCs. Borup et al., Chem Rev 2007, 107, 3904. By switching the polymer electrolyte from an “acidic” condition to a “basic” one, HEMFCs are able to work with non-precious metal catalysts and the catalysts are expected to be more durable. Other less expensive fuel cell components are also possible such as metal bipolar plates. Varcoe, et al., Fuel Cells 2005, 5, 187; Gu et al., Angew Chem Int Edit 2009, 48, 6499; Gu et al., Chem Commun 2013, 49, 131. However, currently available HEMs and HEIs exhibit low alkaline/chemical stability, low hydroxide conductivity, high water uptake, and low mechanical integrity under dry conditions, especially after wet-dry cycles.

Another concern regarding current HEMs/HEIs is their hydroxide conductivity. In comparison to Nafion, HEMs have intrinsically lower ionic conductivities under similar conditions, because the mobility of OH— is lower than that of H+. Hibbs et al., Chem Mater 2008, 20, 2566. Greater ion-exchange capacity (IEC) is needed for HEMs/HEIs to achieve greater hydroxide conductivity. However, high IEC usually leads to a membrane having high water uptake (i.e., a high swelling ratio), decreasing the morphological stability and mechanical strength of the membrane, especially after repeated wet-dry cycles. This highly swollen state when wet is a major reason for decreased flexibility and brittleness of HEMs when dry. The removal of the trade-off between high hydroxide conductivity and low water uptake has been a major setback in designing high-performance HEMs/HEIs. Pan et al., Energ Environ Sci 2013, 6, 2912. Chemical cross-linking, physical reinforcement, side-chain polymerization, and block-copolymer architecture have been tried to reduce water uptake while maintaining acceptable hydroxide conductivity, but these techniques bring challenging problems, e.g., reduced mechanical flexibility, decreased alkaline stability, and/or increased cost. Gu et al., Chem Commun 2011, 47, 2856; Park et al., Electrochem Solid St 2012, 15, B27; Wang et al., Chemsuschem 2015, 8, 4229; Ran et al., Sci Rep-Uk 2014, 4; Tanaka et al., J Am Chem Soc 2011, 133, 10646. Additionally, almost all side-chain or block-copolymer HEMs are based on flexible aliphatic polymer chains due to limited available synthesis methods. As a result, the membranes still cannot provide morphological stability (low swell ratio) at high IECs and high temperature. Wang et al., Chemsuschem 2015, 8, 4229; Ran et al., Sci Rep-Uk 2014, 4; Marino et al., Chemsuschem 2015, 8, 513; Li et al, M. Macromolecules 2015, 48, 6523.

An additional obstacle to using HEMs is achievement of mechanical flexibility and strength in an ambient dry state. Most HEMs exhibit low mechanical strength and are very brittle in a completely dry state especially after being completely swollen. It is difficult to obtain and handle thin membranes that are large in size as needed for commercial use of HEMs. Without good mechanical properties, the ionomers cannot form and keep an adequate triple phase structure in the fuel cell electrode at high temperature, such as at or above 80° C. Li et al., J Am Chem Soc 2013, 135, 10124.

Another highly desirable feature of an HEI is that the polymer be soluble in a mixture of lower boiling alcohol and water but insoluble in pure alcohol or water so that the HEIs can be readily incorporated into an electrode catalyst layer yet not be dissolved away by water or alcohol.

PEMFCs have recently been deployed as zero-emission power sources in commercially sold automobiles, with demonstrated long driving range and short refueling time, which are two features preferred for customer acceptance. However, PEMFCs use platinum electrocatalysts and are not yet cost competitive with gasoline engines. Major approaches to PEMFC cost reduction include development of low-platinum-loading, high power density membrane electrode assemblies (MEAs), and platinum-group-metal-free (PGM-free) cathode catalysts. A fundamentally different pathway to low cost fuel cells is to switch from PEMFCs to hydroxide exchange membrane fuel cells (HEMFCs) that, due to their basic operating environment, can work with PGM-free anode and cathode catalysts, and thus are potentially economically viable. To replace PEMFCs, however, HEMFCs have to provide a performance that matches PEMFCs, performance which in turn requires highly active anode and cathode catalysts as well as the highly chemically stable, ionically conductive, and mechanically robust hydroxide exchange membranes (HEMs)/hydroxide exchange ionomers (HEIs) to build an efficient triple phase boundary and thus drastically improve the utilization of the catalyst particles and reduce the internal resistance.

There is a need for crosslinked and non-crosslinked HEMs/HEIs based on anion exchange polymers, including fluorine-free polymers, that exhibit excellent mechanical properties, high alkaline stability and good conductivity.

### SUMMARY OF THE INVENTION

First and second aspects of the invention are directed to an anion exchange polymer which comprises structural units of formulae 1A, 2A, 3A, optionally 1A-2, and optionally 4A; or structural units of formulae 1A, 1A-2, 3A, and optionally 4A. A sum of mole fractions of the structural units of formulae 1A, 1A-2, 2A and 4A is equal to a mole fraction of formula 3A in the polymer calculated from an amount of monomers used in a polymerization reaction to form the polymer, and a mole ratio of the structural unit of Formula 1A or 1A-2 or 2A or 4A to the structural unit of Formula 3A is from 0.01 to 1 calculated from the amount of monomers used in the polymerization reaction. The structural units of Formulae 1A, 1A-2, 2A, 3A, and 4A have the structures:

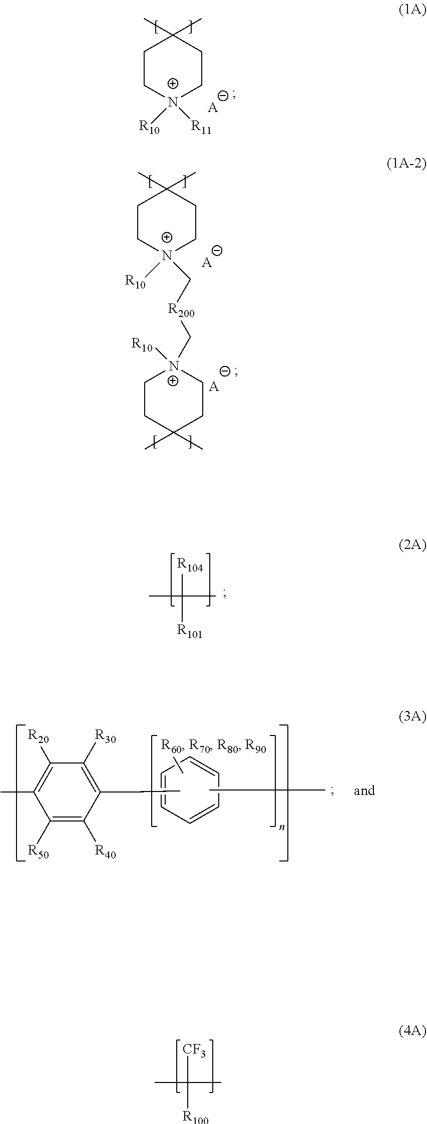

wherein:
A⁻ is an anion;
n is 0, 1, 2 or 3;
q is 0, 1, 2, 3, 4, 5 or 6;
R₁₀ and R₁₁ are each independently hydrogen, alkyl, alkenyl, alkynyl, aryl, a nitrogen-containing heterocyclic group, or a quaternary ammonium or phosphonium group having the formula (6A), the alkyl, alkenyl, alkynyl or aryl being optionally substituted with halide

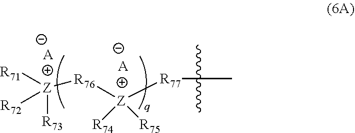

and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₀, R₂₁, R₂₂, R₂₃, R₂₄, R₂₅, R₂₆, R₂₇, R₂₈, R₂₉, R₃₀, R₄₀, R₅₀, R₆₀, R₇₀, R₈₀, R₉₀, R₁₀₄, R₁₃₀, R₁₄₀, R₁₅₀, R₁₆₀, and R₁₇₀ are each independently hydrogen, halide, alkyl, alkenyl, alkynyl or aryl, and the alkyl, alkenyl, alkynyl or aryl are optionally substituted with halide, and wherein R₃₀ and Reo are optionally linked to form a five membered ring optionally substituted with halide or alkyl;
R₇₁, R₇₂, R₇₃, R₇₄ and R₇₅ are each independently alkyl, alkenyl, alkynyl or aryl;
R₇₆ and R₇₇ are each independently alkylene;
each R₁₀₀ is independently alkyl, alkenyl, alkynyl, or

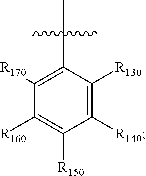

each R₁₀₁ is independently

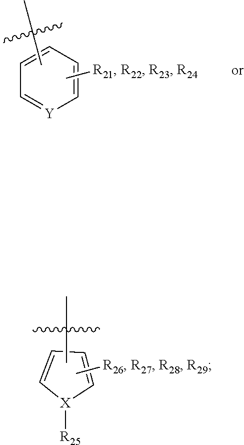

each R₂₀₀ is independently alkylene, arylene, alkenylene, or alkynylene;
X is N, S or O;
Y is C or N; and
Z is N or P.

The first and second aspects of the invention can be provided in terms of monomer reactants rather than as structural units of the polymer. Thus, the first and second aspects of the invention are also directed to an anion exchange polymer that comprises a reaction product of a polymerization mixture comprising: a piperidone monomer or salt or hydrate thereof of formula 1, a ketone monomer of formula 2, an aromatic monomer of formula 3, optionally a trifluoromethyl ketone monomer of formula 4, and optionally a quaternized piperidone of formula 1-2 (first aspect); or the piperidone monomer of formula 1, the quaternized piperidone of formula 1-2, the aromatic monomer of formula 3, and optionally the trifluoromethyl ketone monomer of formula 4 (second aspect). The piperidone monomer or salt or hydrate thereof has the formula:

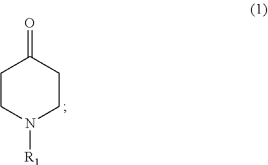

the quaternized piperidone has the formula:

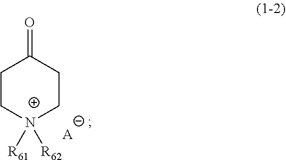

the ketone monomer has the formula:

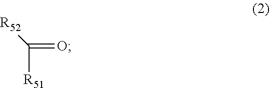

the aromatic monomer has the formula:

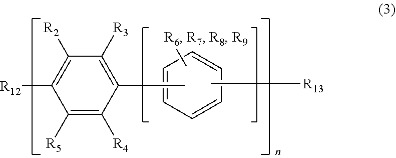

and
the trifluoromethyl ketone monomer has the formula:

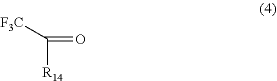

wherein:
A⁻ is an anion;
n is 0, 1, 2 or 3;
R₁, R₂, R₃, R₄, R₅, R₆, R₇, R₈, R₉, R₁₂, R₁₃, R₁₅, R₁₆, R₁₇, R₁₈, R₁₉, R₃₁, R₃₂, R₃₃, R₃₄, R₃₅, R₃₆, R₃₇, R₃₈, R₃₉, R₅₂, R₆₁ and R₆₂ are each independently hydrogen, halide, alkyl, alkenyl, alkynyl or aryl, and the alkyl, alkenyl, alkynyl or aryl are optionally substituted with halide, and wherein R₃ and R₆ are optionally linked to form a five membered ring optionally substituted with halide or alkyl;
each R₁₄ is independently alkyl, alkenyl, alkynyl, or

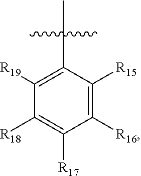

and the alkyl, alkenyl, or alkynyl are optionally substituted with fluoride;
each R₅₁ is independently

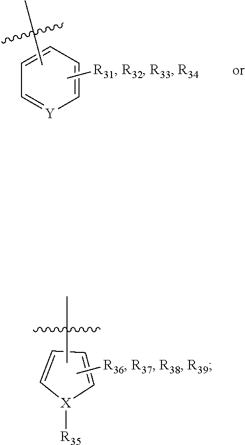

X is N, S or O; and
Y is C or N.

Another polymer is provided which comprises a second reaction product of a second polymerization mixture comprising: a base, an alkylating reagent, and an intermediate polymer; wherein: the intermediate polymer comprises a first reaction product of a first polymerization mixture comprising the piperidone monomer or salt or hydrate thereof having the formula (1); the ketone monomer having the formula (2), the aromatic monomer having the formula (3); and optionally, the trifluoromethyl ketone monomer having the formula (4) (i.e., the first polymerization mixture comprises the monomers of the first aspect of the invention).

A third and fourth aspect of the invention is directed to an anion exchange polymer comprising structural units of formulae 1A, 3A, 4A, 5A, optionally 1A-2, and optionally 2A (third aspect); or structural units of formulae 1A, 2A, 3A, 5A, optionally 1A-2 and optionally 4A (fourth aspect). A sum of mole fractions of the structural units of formulae 1A, 1A-2, 2A, 4A and 5A is equal to a mole fraction of formulae 3A in the polymer calculated from amounts of monomers used in a polymerization reaction to form the polymer, and a mole ratio of the structural unit of formula 1A or 1A-2 or 4A or 5A to the structural unit of formula 3A is from 0.01 to 1 calculated from the amounts of the monomers used in the polymerization reaction. The structural units of formulae 1A, 1A-2, 2A, 3A, 4A and 5A have the structures:

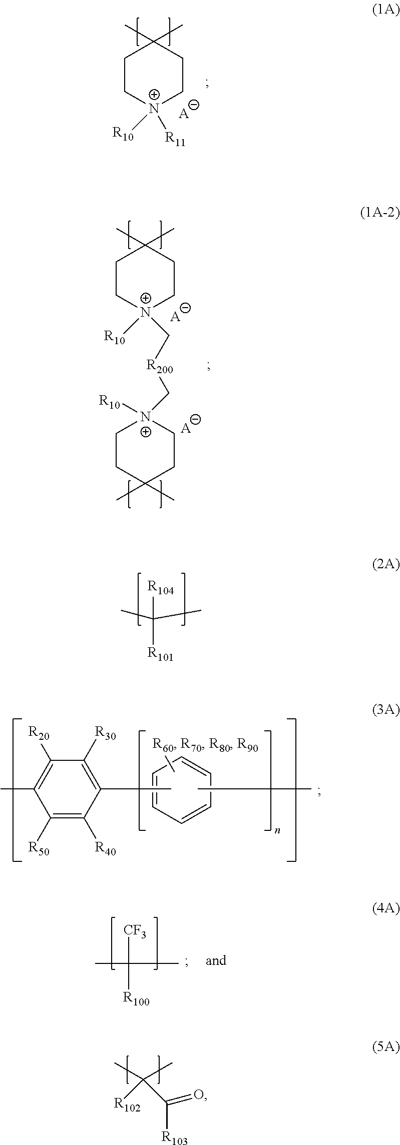

wherein:
A⁻ is an anion;
n is 0, 1, 2 or 3;
q is 0, 1, 2, 3, 4, 5 or 6;
R₁₀ and R₁₁ are each independently hydrogen, alkyl, alkenyl, alkynyl, aryl, a nitrogen-containing heterocyclic group, or a quaternary ammonium or phosphonium group having the formula (6A), the alkyl, alkenyl, alkynyl or aryl being optionally substituted with halide

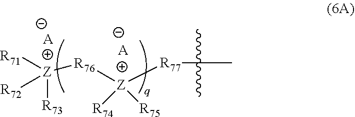

and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₀, R₂₁, R₂₂, R₂₃, R₂₄, R₂₅, R₂₆, R₂₇, R₂₈, R₂₉, R₃₀, R₄₀, R₅₀, R₆₀, R₇₀, R₈₀, R₉₀, R₁₀₄, R₁₃₀, R₁₄₀, R₁₅₀, R₁₆₀, and R₁₇₀ are each independently hydrogen, halide, alkyl, alkenyl, alkynyl or aryl, and the alkyl, alkenyl, alkynyl or aryl are optionally substituted with halide, and wherein R₃₀ and R₆₀ are optionally linked to form a five membered ring optionally substituted with halide or alkyl;
R₇₁, R₇₂, R₇₃, R₇₄ and R₇₅ are each independently alkyl, alkenyl, alkynyl or aryl;
R₇₆ and R₇₇ are each independently alkylene;
each R₁₀₀ is independently alkyl, alkenyl, alkynyl, or

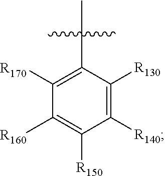

each R₁₀₁ is independently

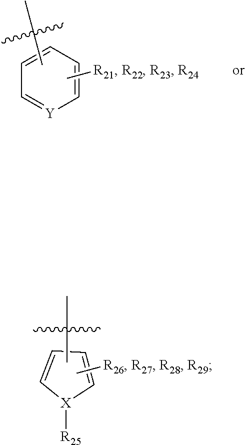

R₁₀₂ and R₁₀₃ are each independently alkyl, alkenyl, alkynyl, amine or aryl, and the alkyl, alkenyl, alkynyl, amine or aryl are optionally substituted with halide or alkyl, and wherein R₁₀₂ and R₁₀₃ are optionally linked to form a five or six membered ring or a polycycle;
each R₂₀₀ is independently alkylene, arylene, alkenylene, or alkynylene;
X is N, S or O;
Y is C or N; and
Z is N or P.

The third and fourth aspects of the invention can be provided in terms of monomer reactants rather than as structural units of the polymer. Thus, the third and fourth aspects of the invention are also directed to an anion exchange polymer comprising a reaction product of a polymerization mixture comprising: a piperidone monomer or salt or hydrate thereof of formula 1, an aromatic monomer of formula 3, a trifluoromethyl ketone monomer of formula 4, a diketone monomer of formula 5, optionally a quaternized piperidone of formula 1-2 and optionally a ketone monomer of formula 2 (third aspect); or the piperidone monomer of formula 1, the ketone monomer of formula 2, the aromatic monomer of formula 3, the diketone monomer of formula 5, optionally the quaternized piperidone of formula 1-2 and optionally the trifluoromethyl ketone monomer of formula 4 (fourth aspect). The piperidone monomer or salt or hydrate thereof has the formula:

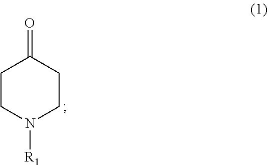

the quaternized piperidone has the formula;

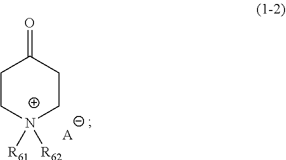

the ketone monomer has the formula:

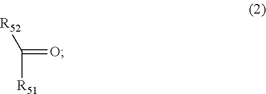

the aromatic monomer has the formula:

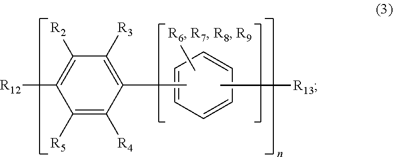

the trifluoromethyl ketone monomer has the formula:

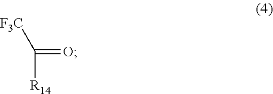

and
the diketone monomer has the formula:

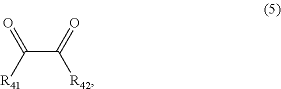

wherein:
A⁻ is an anion;
n is 0, 1, 2 or 3;
R₁, R₂, R₃, R₄, R₅, R₆, R₇, R₈, R₉, R₁₂, R₁₃, R₁₅, R₁₆, R₁₇, R₁₈, R₁₉, R₃₁, R₃₂, R₃₃, R₃₄, R₃₅, R₃₆, R₃₇, R₃₈, R₃₉, R₅₂, R₆₁ and R₆₂ are each independently hydrogen, halide, alkyl, alkenyl, alkynyl or aryl, and the alkyl, alkenyl, alkynyl or aryl are optionally substituted with halide, and wherein R₃ and R₆ are optionally linked to form a five membered ring optionally substituted with halide or alkyl;
each R₁₄ is independently alkyl, alkenyl, alkynyl, or

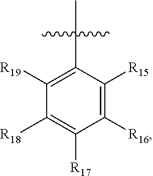

and the alkyl, alkenyl, or alkynyl are optionally substituted with fluoride;
R₄₁ and R₄₂ are each independently alkyl, alkenyl, alkynyl, amine or aryl, and the alkyl, alkenyl, alkynyl, amine or aryl are optionally substituted with halide or alkyl, and wherein R₄₁ and R₄₂ are optionally linked to form a five or six membered ring or a polycycle;
each R₅₁ is independently

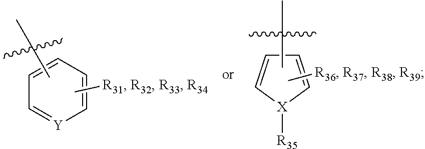

X is N, S or O; and
Y is C or N.

Another polymer is provided which comprises a second reaction product of a second polymerization mixture comprising: a base, an alkylating reagent and an intermediate polymer; wherein the intermediate polymer comprises a first reaction product of a first polymerization mixture comprising: the piperidone monomer or salt or hydrate thereof having the formula (1); optionally, the ketone monomer having the formula (2); the aromatic monomer having the formula (3); the trifluoromethyl ketone monomer having the formula (4); and the diketone monomer having the formula (5) (i.e., the first polymerization mixture comprises the monomers of the third aspect of the invention).

Another polymer is provided which comprises a second reaction product of a second polymerization mixture comprising: a base, an alkylating reagent and an intermediate polymer; wherein the intermediate polymer comprises a first reaction product of a first polymerization mixture comprising: the piperidone monomer or salt or hydrate thereof having the formula (1); the ketone monomer having the formula (2); the aromatic monomer having the formula (3); optionally, the trifluoromethyl ketone monomer having the formula (4); and the diketone monomer having the formula (5) (i.e., the first polymerization mixture comprises the monomers of the fourth aspect of the invention).

A neutralized polymer is also provided, the neutralized polymer comprising a reaction product of a base and the polymer of one of the first, second, third, or fourth aspects of the invention. Another alkylated polymer is provided, the alkylated polymer comprising a reaction product of an alkylating agent and the neutralized polymer. Another polymer comprises the reaction product of a base and the alkylated polymer.

An anion exchange membrane is also provided, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, and the anion exchange membrane comprising any of the anion exchange polymers as described above.

An anion exchange membrane fuel cell, electrolyzer, electrodialyzer, solar hydrogen generator, flow battery, desalinator, sensor, demineralizer, water purifier, waste water treatment system, ion exchanger, or CO₂ separator is also provided, the fuel cell, electrolyzer, electrodialyzer, solar hydrogen generator, flow battery, desalinator, sensor, demineralizer, water purifier, waste water treatment system, ion exchanger, or CO₂ separator is provided, comprising any of the anion exchange polymers as described above.

Also provided is a reinforced electrolyte membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator. The membrane comprises a porous substrate impregnated with any of the anion exchange polymers as described above.

A method of making an anion exchange polymer as described above is provided. The method comprises: reacting the quaternized piperidone monomer with the aromatic monomer, the optional ketone monomer, the optional trifluoromethyl ketone and the optional diketone monomer in the presence of an organic solvent and a polymerization catalyst to form a piperidinium-functionalized polymer; and exchanging anions of the piperidinium-functionalized polymer with halide, hydroxide, bicarbonate, or carbonate ions or a combination thereof to form the anion exchange polymer.

Another method of making an anion exchange polymer as described above is provided. The method comprises: reacting the piperidone monomer with the aromatic monomer, the optional ketone monomer, the optional trifluoromethyl ketone and the optional diketone monomer in the presence of an organic solvent and a polymerization catalyst to form an acidified intermediate polymer; reacting the acidified intermediate polymer with a base to form a piperidine-functionalized polymer; alkylating the piperidine-functionalized intermediate polymer in the presence of an organic solvent to form apiperidinium-functionalized intermediate polymer; and reacting the piperidinium-functionalized intermediate polymer with halide, hydroxide, bicarbonate, or carbonate ions or a combination thereof to form the anion exchange polymer.

Yet another method of making an anion exchange polymer membrane as described above is provided. The method comprises: reacting the piperidone monomer with the aromatic monomer, the optional ketone monomer, the optional trifluoromethyl ketone and the optional diketone monomer in the presence of an organic solvent and a polymerization catalyst to form an acidified intermediate polymer; reacting the acidified intermediate polymer with a base to form a neutral piperidine-functionalized polymer; reacting the neutral piperidine-functionalized polymer with an alkylating agent to form a piperidinium-functionalized polymer; exchanging anions of the piperidinium-functionalized polymer with hydroxide, bicarbonate, or carbonate ions or a combination thereof to form the anion exchange polymer; dissolving the anion exchange polymer in a solvent to form a polymer suspension or solution; and casting the polymer suspension or solution to form the anion exchange polymer membrane.

A method of making a crosslinked anion exchange polymer comprising the anion exchange polymer as described above is provided. The method comprises: reacting the piperidone monomer with the aromatic monomer, the optional ketone monomer, the optional trifluoromethyl ketone and the optional diketone monomer in the presence of an organic solvent and a polymerization catalyst to form an acidified polymer; reacting the acidified polymer with a base to form a neutral piperidine-functionalized polymer; partially quaternizing the neutral piperidine-functionalized polymer with an alkylating agent to form a partially quaternized piperidinium-functionalized polymer having piperidine groups available for crosslinking; reacting the partially quaternized piperidinium-functionalized polymer with a crosslinking reagent to form a crosslinked polymer; exchanging anions of the crosslinked polymer with halide, hydroxide, bicarbonate, or carbonate ions or a combination thereof to form the crosslinked anion exchange polymer; and optionally reacting the crosslinked anion exchange polymer with trimethyl amine to quaternize partially reacted crosslinking reagent.

Another method of making a crosslinked anion exchange polymer comprising the anion exchange polymer as described above is provided. The method comprises: reacting the piperidone monomer with the aromatic monomer, the optional ketone monomer, the optional trifluoromethyl ketone and the optional diketone monomer in the presence of an organic solvent and a polymerization catalyst to form an acidified polymer; reacting the acidified polymer with a base to form a neutral piperidine-functionalized polymer; partially quaternizing the neutral piperidine-functionalized polymer with a crosslinking reagent to form a crosslinked polymer; reacting the crosslinked polymer with an alkylating agent to form a fully quaternized crosslinked polymer; and exchanging anions of the fully quaternized crosslinked polymer with halide, hydroxide, bicarbonate, or carbonate ions or a combination thereof to form the crosslinked anion exchange polymer.

Yet another method of making a crosslinked polymer membrane or a crosslinked anion exchange polymer membrane comprising the anion exchange polymer as described above is provided. The method comprises: reacting the piperidone monomer with the aromatic monomer, the optional ketone monomer, the optional trifluoromethyl ketone and the optional diketone monomer in the presence of an organic solvent and a polymerization catalyst to form an acidified polymer; reacting the acidified polymer with a base to form a neutral piperidine-functionalized polymer; reacting the neutral piperidine-functionalized polymer with an alkylating agent to form a piperidinium-functionalized polymer while leaving part of the neutral piperidine intact for crosslinking; optionally exchanging anions of the piperidinium-functionalized polymer with hydroxide, bicarbonate, or carbonate ions or a combination thereof to form an anion exchange polymer; dissolving the piperidinium-functionalized polymer or the anion exchange polymer in a solvent to form a polymer suspension or solution; adding a crosslinking reagent to the polymer suspension or solution and casting to form the crosslinked polymer membrane or the crosslinked anion exchange polymer membrane; optionally reacting the crosslinked polymer membrane or the crosslinked anion exchange polymer membrane with trimethyl amine to quaternize partially reacted crosslinking reagent; and optionally exchanging anions of the crosslinked polymer membrane or the crosslinked anion exchange polymer membrane with hydroxide, bicarbonate, or carbonate ions or a combination thereof.

Other objects and features will be in part apparent and in part pointed out hereinafter.

### BRIEF DESCRIPTION OF THE DRAWINGS

FIG. 1A illustrates an exemplary hydroxide exchange membrane fuel cell.

FIG. 1B illustrates an exemplary hydroxide exchange membrane electrolyzer.

FIG. 2 depicts an 1H NMR spectrum of P-Neutral-0.85 in CDCl₃

FIG. 3 depicts an 1H NMR spectrum of P-Me-0.85-0.15 in DMSO-d6.

### DESCRIPTION OF THE PREFERRED EMBODIMENTS

Anion exchange polymers have now been discovered which, when crosslinked, exhibit reduced swelling and water uptake and increased conductivity, which are beneficial to a membrane and its performance in electrochemical devices. Such polymers can be fluorine-free polymers.

HEMs/HEIs formed from poly(aryl alkylene) polymers with various pendant piperidinium-functionalized groups and having intrinsic hydroxide conduction channels have been discovered which can provide increased chemical stability, greater conductivity, decreased water uptake, good solubility in selected solvents, and/or mechanical properties, and other attributes relevant to HEM/HEI performance. For example, HEMs/HEIs formed from these polymers can exhibit superior chemical stability, anion conductivity, decreased water uptake, good solubility in selected solvents, and improved mechanical properties in an ambient dry state as compared to conventional HEM/HEIs. The inventive HEMFCs can exhibit enhanced performance and durability at relatively high temperatures.

First and second aspects of the invention are directed to an anion exchange polymer which comprises structural units of formulae 1A, 2A, 3A, optionally 1A-2, and optionally 4A (first aspect); or structural units of formulae 1A, 1A-2, 3A, and optionally 4A (second aspect). A sum of mole fractions of the structural units of formulae 1A, 1A-2, 2A and 4A is equal to a mole fraction of formula 3A in the polymer calculated from an amount of monomers used in a polymerization reaction to form the polymer, and a mole ratio of the structural unit of Formula 1A or 1A-2 or 2A or 4A to the structural unit of Formula 3A is from 0.01 to 1 calculated from the amount of monomers used in the polymerization reaction. The structural units of Formulae 1A, 1A-2, 2A, 3A, and 4A have the structures:

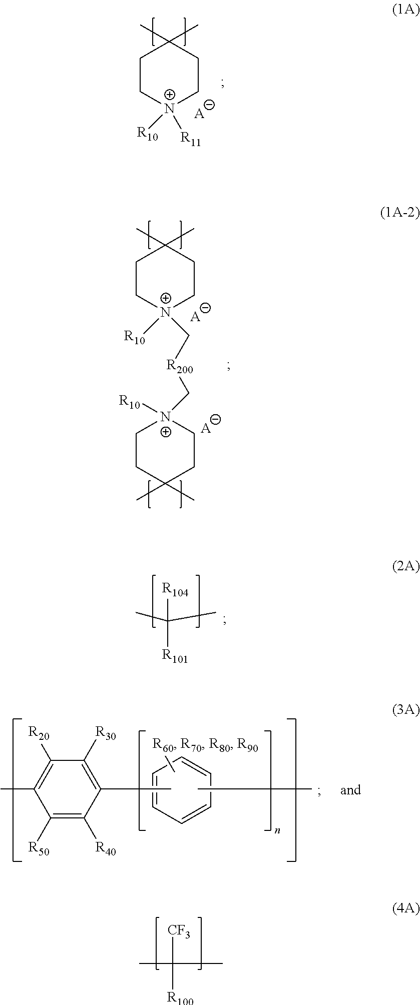

wherein:
A⁻ is an anion;
n is 0, 1, 2 or 3;
q is 0, 1, 2, 3, 4, 5 or 6;
R₁₀ and R₁₁ are each independently hydrogen, alkyl, alkenyl, alkynyl, aryl, a nitrogen-containing heterocyclic group, or a quaternary ammonium or phosphonium group having the formula (6A), the alkyl, alkenyl, alkynyl or aryl being optionally substituted with halide

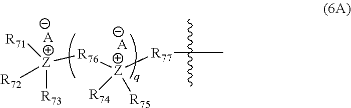

and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₀, R₂₁, R₂₂, R₂₃, R₂₄, R₂₅, R₂₆, R₂₇, R₂₈, R₂₉, R₃₀, R₄₀, R₅₀, R₆₀, R₇₀, R₈₀, R₉₀, R₁₀₄, R₁₃₀, R₁₄₀, R₁₅₀, R₁₆₀, and R₁₇₀ are each independently hydrogen, halide, alkyl, alkenyl, alkynyl or aryl, and the alkyl, alkenyl, alkynyl or aryl are optionally substituted with halide, and wherein R₃₀ and Reo are optionally linked to form a five membered ring optionally substituted with halide or alkyl;
R₇₁, R₇₂, R₇₃, R₇₄ and R₇₅ are each independently alkyl, alkenyl, alkynyl or aryl;
R₇₆ and R₇₇ are each independently alkylene;
each R₁₀₀ is independently alkyl, alkenyl, alkynyl, or

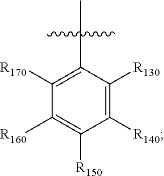

each R₁₀₁ is independently

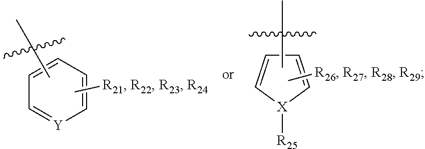

each R₂₀₀ is independently alkylene, arylene, alkenylene, or alkynylene;
X is N, S or O;
Y is C or N; and
Z is N or P.

In the first aspect, the polymer can comprise the structural units of formulae 1A, 2A, and 3A; 1A, 1A-2, 2A, and 3A; 1A, 2A, 3A and 4A; or 1A, 1A-2, 2A, 3A and 4A.

In the second aspect, the polymer can comprise the structural units of formulae 1A, 1A-2, and 3A; or 1A, 1A-2, 3A and 4A.

In the first and second aspects of the invention, the mole ratio of a sum of the mole fractions of the structural unit of Formula 1A or Formula 1A-2, Formula 2A and Formulae 4A to the mole fraction of Formulae 3A in the polymer can be from about 0.95:1 to about 1.4:1, and the ratio of the mole fraction of the structural unit of Formula 1A or Formula 1A-2 to the mole fraction of the structural unit of Formula 3A can be from about 0.01 to 1. Alternatively, the mole ratio of a sum of the mole fractions of the structural unit of Formula 1A or Formula 1A-2, Formula 2A and Formulae 4A to the mole fraction of Formulae 3A in the polymer can be from about 1:1 to about 1.2:1.

The first and second aspects of the invention can be provided in terms of monomer reactants rather than as structural units of the polymer. When the first and second aspects of the invention are expressed in terms of monomer reactants, an anion exchange polymer is provided that comprises a reaction product of a polymerization mixture comprising: a piperidone monomer or salt or hydrate thereof of formula 1, a ketone monomer of formula 2, an aromatic monomer of formula 3, optionally a trifluoromethyl ketone monomer of formula, 4 and optionally a quaternized piperidone of formula 1-2 (first aspect); or the piperidone monomer of formula 1, the quaternized piperidone of formula 1-2, the aromatic monomer of formula 3, and optionally the trifluoromethyl ketone monomer of formula 4 (second aspect). The piperidone monomer or salt or hydrate thereof has the formula:

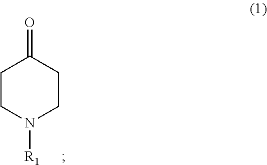

the quaternized piperidone has the formula:

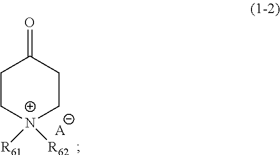

the ketone monomer has the formula:

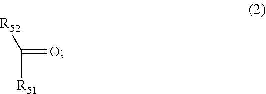

the aromatic monomer has the formula:

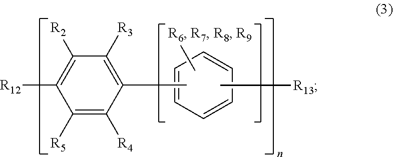

and
the trifluoromethyl ketone monomer has the formula:

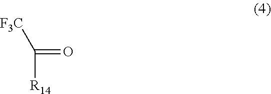

wherein:
A⁻ is an anion;
n is 0, 1, 2 or 3;

R₁, R₂, R₃, R₄, R₅, R₆, R₇, R₈, R₉, R₁₂, R₁₃, R₁₅, R₁₆, R₁₇, R₁₈, R₁₉, R₃₁, R₃₂, R_{33,} R₃₄, R₃₅, R₃₆, R₃₇, R₃₈, R₃₉, R₅₂, R₆₁ and R₆₂ are each independently hydrogen, halide, alkyl, alkenyl, alkynyl or aryl, and the alkyl, alkenyl, alkynyl or aryl are optionally substituted with halide, and wherein R₃ and R₆ are optionally linked to form a five membered ring optionally substituted with halide or alkyl;
each R₁₄ is independently alkyl, alkenyl, alkynyl, or

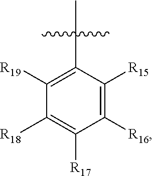

and the alkyl, alkenyl, or alkynyl are optionally substituted with fluoride;
each R₅₁ is independently

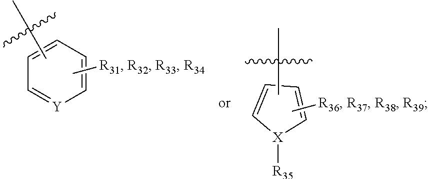

X is N, S or O; and
Y is C or N.

In the first aspect, the polymer can comprise the monomers of formulae 1, 2, and 3; 1, 1-2, 2, and 3; 1, 2, 3 and 4; or 1, 1-2, 2, 3 and 4.

In the second aspect, the polymer can comprise the monomers of formulae 1, 1-2, and 3; or 1, 1-2, 3 and 4.

A third and fourth aspect of the invention is directed to an anion exchange polymer comprising structural units of formulae 1A, 3A, 4A, 5A, optionally 1A-2, and optionally 2A (third aspect); or structural units of formulae 1A, 2A, 3A, 5A, optionally 1A-2 and optionally 4A (fourth aspect). A sum of mole fractions of the structural units of formulae 1A, 1A-2, 2A, 4A and 5A is equal to a mole fraction of formulae 3A in the polymer calculated from amounts of monomers used in a polymerization reaction to form the polymer, and a mole ratio of the structural unit of formula 1A or 1A-2 or 4A or 5A to the structural unit of formula 3A is from 0.01 to 1 calculated from the amounts of the monomers used in the polymerization reaction. The structural units of formulae 1A, 1A-2, 2A, 3A, 4A and 5A have the structures:

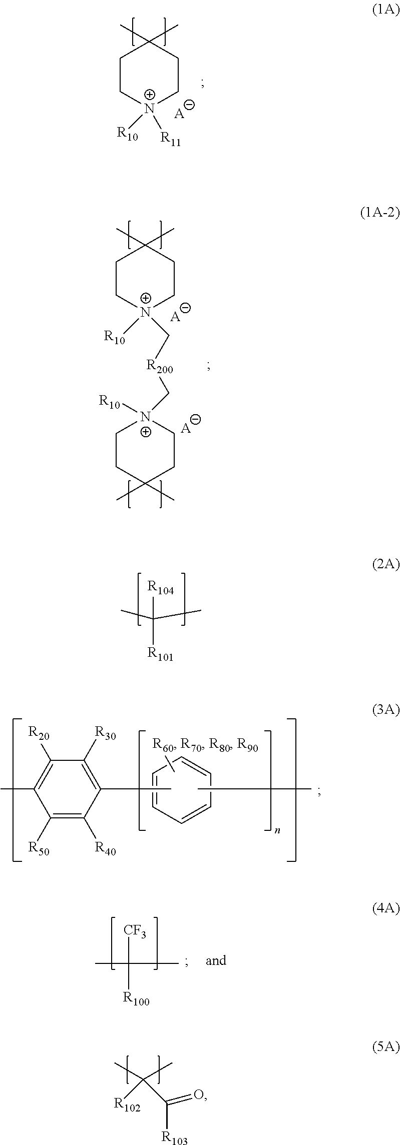

wherein:
A⁻ is an anion;
n is 0, 1, 2 or 3;
q is 0, 1, 2, 3, 4, 5 or 6;
R₁₀ and R₁₁ are each independently hydrogen, alkyl, alkenyl, alkynyl, aryl, a nitrogen-containing heterocyclic group, or a quaternary ammonium or phosphonium group having the formula (6A), the alkyl, alkenyl, alkynyl or aryl being optionally substituted with halide

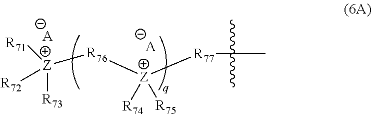

and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₀, R₂₁, R₂₂, R₂₃, R₂₄, R₂₅, R₂₆, R₂₇, R₂₈, R₂₉, R₃₀, R₄₀, R₅₀, R₆₀, R₇₀, R₈₀, R₉₀, R₁₀₄, R₁₃₀, R₁₄₀, R₁₅₀, R₁₆₀, and R₁₇₀ are each independently hydrogen, halide, alkyl, alkenyl, alkynyl or aryl, and the alkyl, alkenyl, alkynyl or aryl are optionally substituted with halide, and wherein R₃₀ and R₆₀ are optionally linked to form a five membered ring optionally substituted with halide or alkyl;
R₇₁, R₇₂, R₇₃, R₇₄ and R₇₅ are each independently alkyl, alkenyl, alkynyl or aryl;
R₇₆ and R₇₇ are each independently alkylene;
each R₁₀₀ is independently alkyl, alkenyl, alkynyl, or

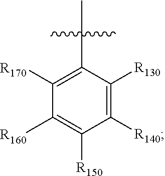

each R₁₀₁ is independently

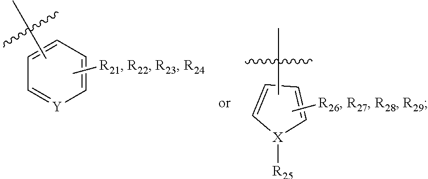

R₁₀₂ and R₁₀₃ are each independently alkyl, alkenyl, alkynyl, amine or aryl, and the alkyl, alkenyl, alkynyl, amine or aryl are optionally substituted with halide or alkyl, and wherein R₁₀₂ and R₁₀₃ are optionally linked to form a five or six membered ring or a polycycle;
each R₂₀₀ is independently alkylene, arylene, alkenylene, or alkynylene;
X is N, S or O; p1 Y is C or N; and
Z is N or P.

In the third aspect, the polymer can comprise the structural units of formulae 1A, 3A, 4A, and 5A; 1A, 1A-2, 3A, 4A, and 5A; or 1A, 2A, 3A, 4A, and 5A.

In the fourth aspect, the polymer can comprise the structural units of formulae 1A, 2A, 3A, and 5A; 1A, 1A-2 2A, 3A, and 5A; 1A, 2A, 3A, 4A, and 5A; or 1A, 1A-2, 2A, 3A, 4A, and 5A.

In the third and fourth aspects of the invention, the mole ratio of a sum of the mole fractions of the structural unit of Formula 1A or Formula 1A-2, Formula 2A, Formulae 4A and Formulae 5A to the mole fraction of Formulae 3A in the polymer can be from about 0.95:1 to about 1.4:1, and the ratio of the mole fraction of the structural unit of Formula 1A or Formula 1A-2 to the mole fraction of the structural unit of Formula 3A can be from about 0.01 to 1. Alternatively, the mole ratio of a sum of the mole fractions of the structural unit of Formula 1A or Formula 1A-2, Formula 2A, Formulae 4A and Formulae 5A to the mole fraction of Formulae 3A in the polymer can be from about 1:1 to about 1.2:1.

The third and fourth aspects of the invention can be provided in terms of monomer reactants rather than as structural units of the polymer. Thus, the third and fourth aspects of the invention are also directed to an anion exchange polymer comprising a reaction product of a polymerization mixture comprising: a piperidone monomer or salt or hydrate thereof of formula 1, an aromatic monomer of formula 3, a trifluoromethyl ketone monomer of formula 4, a diketone monomer of formula 5, optionally a quaternized piperidone of formula 1-2 and optionally a ketone monomer of formula 2 (third aspect); or the piperidone monomer of formula 1, the ketone monomer of formula 2, the aromatic monomer of formula 3, the diketone monomer of formula 5, optionally the quaternized piperidone of formula 1-2 and optionally the trifluoromethyl ketone monomer of formula 4 (fourth aspect). The piperidone monomer or salt or hydrate thereof has the formula:

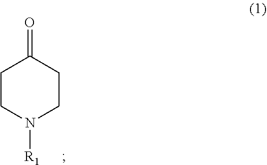

the quaternized piperidone has the formula;

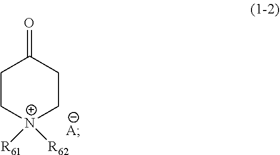

the ketone monomer has the formula:

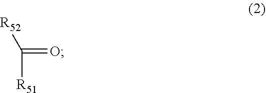

the aromatic monomer has the formula:

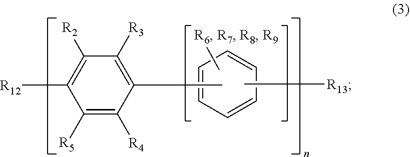

the trifluoromethyl ketone monomer has the formula:

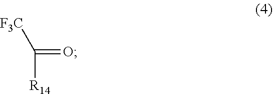

and
the diketone monomer has the formula.

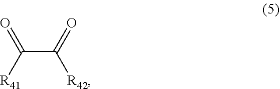

wherein:
A⁻ is an anion;
n is 0, 1, 2 or 3;
R₁, R₂, R₃, R₄, R₅, R₆, R₇, R₈, R₉, R₁₂, R₁₃, R₁₅, R₁₆, R₁₇, R₁₈, R₁₉, R₃₁, R₃₂, R₃₃, R₃₄, R₃₅, R₃₆, R₃₇, R₃₈, R₃₉, R₅₂, R₆₁ and R₆₂ are each independently hydrogen, halide, alkyl, alkenyl, alkynyl or aryl, and the alkyl, alkenyl, alkynyl or aryl are optionally substituted with halide, and wherein R₃ and R₆ are optionally linked to form a five membered ring optionally substituted with halide or alkyl;
each R₁₄ is independently alkyl, alkenyl, alkynyl, or

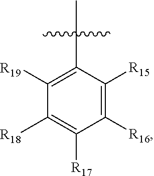

and the alkyl, alkenyl, or alkynyl are optionally substituted with fluoride;

R₄₁ and R₄₂ are each independently alkyl, alkenyl, alkynyl, amine or aryl, and the alkyl, alkenyl, alkynyl, amine or aryl are optionally substituted with halide or alkyl, and wherein R₄₁ and R₄₂ are optionally linked to form a five or six membered ring or a polycycle;
each R₅₁ is independently

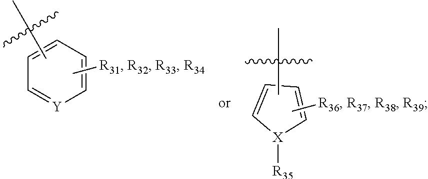

X is N, S or O; and
Y is C or N.

In the third aspect, the polymer can comprise the monomers of formulae 1, 3, 4, and 5; 1, 1-2, 3, 4, and 5; or 1, 2, 3, 4, and 5.

In the fourth aspect, the polymer can comprise the monomers of formulae 1, 2, 3, and 5; 1, 1-2, 2, 3, and 5; 1, 2, 3, 4, and 5; or 1, 1-2, 2, 3, 4, and 5.
R₁₀ and R₁₁ of the structural unit of formula (1A) or R₁₀ of the structural unit of formula (1A-2) of any of the anion exchange polymers described herein can comprise alkyl, alkenyl, alkynyl or aryl, a quaternary ammonium or phosphonium compound of the formula (6A), or any combination of thereof.

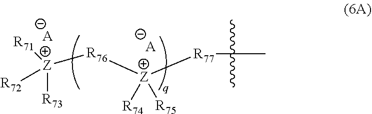

Preferably, in the quaternary ammonium or phosphonium compound of formula (6A), R₇₆ and R₇₇ are each independently C₁-C₂₂ alkylene; R₇₁, R₇₂, R₇₃, R₇₄ and R₇₅ are each independently C₁-C₆ alkyl; q is 0, 1, 2, 3, 4, 5, or 6; Z is N or P; and A⁻ is an anion.

Preferably, in the quaternary ammonium or phosphonium compound of formula (6A), R₇₆ and R₇₇ are independently C₁-C₆ alkylene; R₇₁, R₇₂, R₇₃, R₇₄ and R₇₅ are each independently C₁-C₆ alkyl; q is 0, 1, 2 or 3; Z is N; and A⁻ is an anion. For example the ammonium compound can have the formula:

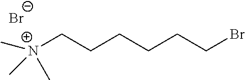

or the structural unit:

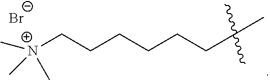

The nitrogen-containing heterocycle in any of the anion exchange polymers described herein can comprise an imidazolium having the formula (7A):

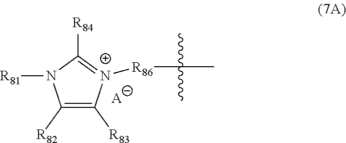

wherein: R₈₁, R₈₂, R₈₃, R₈₄ and R₈₆ are each independently optionally substituted alkyl, alkenyl, alkynyl, or aryl; and A⁻ is an anion. Preferably, R₈₄ is 2,4,6-alkylphenyl, and R₈₁, R₈₂, R₈₃ and R₈₆ are each independently C₁-C₆ alkyl. For example, the imidazolium can have the formula:

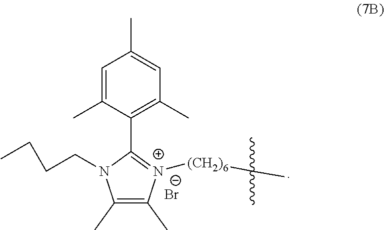

The piperidone monomer has the formula:

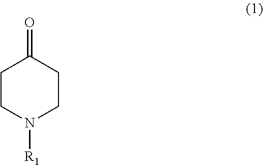

wherein R₁ is each independently hydrogen, alkyl, alkenyl, or alkynyl, and the alkyl, alkenyl or alkynyl are optionally substituted with fluoride. Preferably, R₁ is alkyl such as methyl, ethyl, propyl, butyl, pentyl, or hexyl. Preferably, the piperidone monomer or salt or hydrate thereof comprises N-methyl-4-piperidone or 4-piperidone.

The salt of the piperidone monomer can comprise hydrochloride, hydrofluoride, hydrobromide, hydroiodide, trifluoroacetate, acetate, triflate, methanesulfonate, sulfate, nitrate, tetrafluoroborate, hexafluorophosphate, formate, benzenesulfonate, toluate, perchlorate, or benzoate, or any hydrate of the salt, or any combination thereof.

The salt of the piperidone monomer can comprise 4-piperidone hydrofluoride, 4-piperidone hydrochloride, 4-piperidone hydrobromide, 4-piperidone hydroiodide, 4-piperidone trifluoroacetate, 4-piperidone tetrafluoroborate, 4-piperidone hexafluorophosphate, 4-piperidone acetate, 4-piperidone triflate, 4-piperidone methanesulfonate, 4-piperidone formate, 4-piperidone benzenesulfonate, 4-piperidone toluate, 4-piperidone sulfate, 4-piperidone nitrate, 4-piperidone perchlorate, 4-piperidone benzoate, N-methyl-4-piperidone hydrofluoride, N-methyl-4-piperidone hydrochloride, N-methyl-4-piperidone hydrobromide, N-methyl-4-piperidone hydroiodide, N-methyl-4-piperidone trifluoroacetate, N-methyl-4-piperidone tetrafluoroborate, N-methyl-4-piperidone hexafluorophosphate, N-methyl-4-piperidone acetate, N-methyl-4-piperidone triflate, N-methyl-4-piperidone methanesulfonate, N-methyl-4-piperidone formate, N-methyl-4-piperidone benzenesulfonate, N-methyl-4-piperidone toluate, N-methyl-4-piperidone sulfate, N-methyl-4-piperidone nitrate, N-methyl-4-piperidone perchlorate, N-methyl-4-piperidone benzoate or any hydrate of the salt, or any combination thereof.

The quaternized piperidone monomer has the formula:

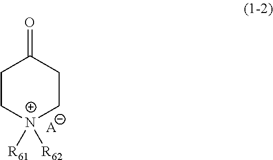

wherein: R₆₁ and R₆₂ are each independently hydrogen, alkyl, alkenyl, or alkynyl, and the alkyl, alkenyl or alkynyl are optionally substituted with fluoride; and A is an anion such as halide, tetrafluoroborate, hexafluorophosphate, bicarbonate, carbonate or hydroxide. Preferably, both R₆₁ and R₆₂ are alkyl, and the anion is halide. Preferably, the quaternized piperidone monomer can comprise 1,1-dimethyl-4-oxopiperidin-1-ium iodide:

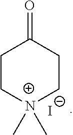

The structural unit of formula 2A can be:

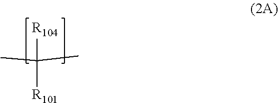

wherein:
each R₁₀₁ is independently

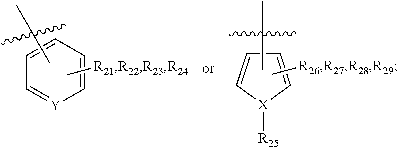

R₂₁, R₂₂, R₂₃, R₂₄, R₂₅, R₂₆, R₂₇, R₂₈, and R₂₉ are each independently hydrogen, halide, alkyl, alkenyl, alkynyl or aryl, and the alkyl, alkenyl, alkynyl or aryl are optionally substituted with halide;
R₁₀₄ is hydrogen, halide, alkyl, alkenyl, alkynyl or aryl, and the alkyl, alkenyl, alkynyl or aryl are optionally substituted with halide;
X is N, S or O; and
Y is C or N. Preferably, R₁₀₄ is alkyl such as methyl, ethyl, propyl, butyl, pentyl, or hexyl; Y is N; X is N, S or O; and R₂₁, R₂₂, R₂₃, R₂₄, R₂₅, R₂₆, R₂₇, R₂₈, R₂₉ and R₁₀₁ are each hydrogen.

The ketone monomer has the formula:

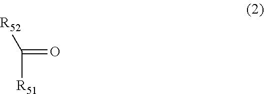

wherein, R₅₁ has a formula of:

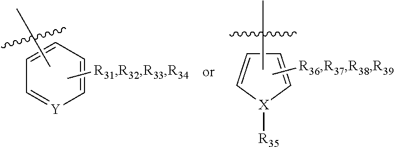

R₃₁, R₃₂, R₃₃, R₃₄, R₃₅, R₃₆, R₃₇, R₃₈, R₃₉ and R₅₂ are each independently hydrogen, halide, alkyl, alkenyl, alkynyl or aryl, and the alkyl, alkenyl, alkynyl or aryl are optionally substituted with halide; Y is C or N; and X is N, S or O. Preferably, R₅₂ is alkyl such as methyl, ethyl, propyl, butyl, pentyl, or hexyl; Y is N; X is N, S or O; and R₃₁, R₃₂, R₃₃, R₃₄, R₃₅, R₃₆, R₃₇, R₃₈, R₃₉ and R₅₂ are each hydrogen. Preferably, the ketone monomer of the formula (2) can be 4-acetylpyridine:

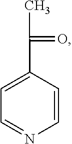

3-acetylpyridine, 2-acetylpyridine, 2-acetylpyrrole, 2-furyl methyl ketone or 3-acetylthiophene, or any combination thereof.

The structural unit of formula 3A can be:

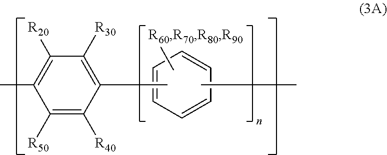

wherein R₂₀, R₃₀, R₄₀, R₅₀, R₆₀, R₇₀, R₈₀, and R₉₀ are each independently hydrogen, halide, alkyl, alkenyl, alkynyl or aryl, and the alkyl, alkenyl, alkynyl or aryl are optionally substituted with halide, and wherein R₃₀ and R₆₀ are optionally linked to form a five membered ring optionally substituted with halide or alkyl; and n is 0, 1, 2 or 3. Preferably, R₂₀, R₃₀, R₄₀, R₅₀, R₆₀, R₇₀, R₈₀, and R₉₀ are each independently hydrogen, or alkyl optionally substituted with fluoride, such as methyl, ethyl, propyl, butyl, pentyl or hexyl or methyl, ethyl, propyl, butyl, pentyl, or hexyl substituted with fluoride.

The aromatic monomer has the formula:

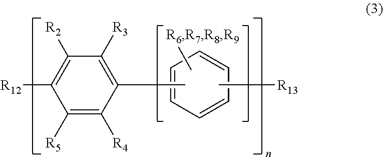

wherein R₂, R₃, R₄, R₅, R₆, R₇, R₈, R₉, R₁₂ and R₁₃ are each independently hydrogen, halide, alkyl, alkenyl, alkynyl or aryl, and the alkyl, alkenyl, alkynyl or aryl are optionally substituted with halide, and wherein R₃ and R₆ are optionally linked to form a five membered ring optionally substituted with halide or alkyl; and n is 0, 1, 2 or 3. Preferably, R₂, R₃, R₄, R₅, R₆, R₇, R₈, R₉, R₁₂ and R₁₃ are each independently hydrogen, or alkyl optionally substituted with fluoride, such as methyl, ethyl, propyl, butyl, pentyl or hexyl or methyl, ethyl, propyl, butyl, pentyl, or hexyl substituted with fluoride. Preferably, the aromatic monomer comprises biphenyl, para-terphenyl, m-terphenyl, para-quaterphenyl, 1,3,5-Triphenylbenzene, 9,9-dimethylfluorene, benzene or any combination thereof.

The structural unit of formula 4A can be: 1

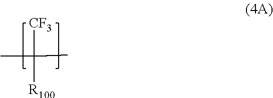

wherein each R₁₀₀ is independently alkyl, alkenyl, alkynyl, or

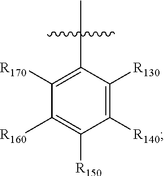

and

R₁₃₀, R₁₄₀, R₁₅₀, R₁₆₀, and R₁₇₀ are each independently hydrogen, halide, alkyl, alkenyl, alkynyl or aryl, and the alkyl, alkenyl, alkynyl or aryl are optionally substituted with halide. Preferably, R₁₃₀, R₁₄₀, R₁₅₀, R₁₆₀ and R₁₇₀ are each independently hydrogen or alkyl optionally substituted with fluoride, such as methyl, ethyl, propyl, butyl, pentyl, or hexyl substituted with fluoride.

The trifluoromethyl ketone monomer has the formula:

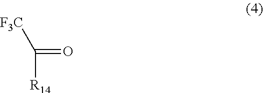

wherein each R₄ is independently alkyl, alkenyl, alkynyl, or

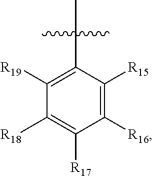

and the alkyl, alkenyl, or alkynyl are optionally substituted with halide; R₁₅, R₁₆, R₁₇, R₁₈ and R₁₉ are each independently hydrogen, halide, alkyl, alkenyl, alkynyl or aryl, and the alkyl, alkenyl, alkynyl or aryl are optionally substituted with halide. Preferably, R₁₅, R₁₆, R₁₇, R₁₈ and R₁₉ are each independently hydrogen or alkyl optionally substituted with fluoride, such as methyl, ethyl, propyl, butyl, pentyl, or hexyl substituted with fluoride. Preferably, the trifluoromethyl ketone monomer comprises 2,2,2-trifluoroacetophenone or 1,1,1-trifluoroacetone.

The structural unit of formula 5A can be:

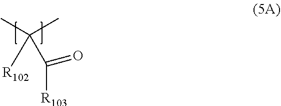

wherein R₁₀₂ and R₁₀₃ are each independently alkyl, alkenyl, alkynyl, amine or aryl, and the alkyl, alkenyl, alkynyl, amine or aryl are optionally substituted with halide or alkyl, and wherein R₁₀₂ and R₁₀₃ are optionally linked to form a five or six membered ring or a polycycle. The polycycle can have two or more hydrocarbon rings which can be substituted with heteroatoms such as nitrogen or oxygen. The polycycle can be aromatic or non-aromatic. Preferably, the structural unit of formula 5A is derived from isatin, 5-bromoisatin, 5-methylisatin, 5-nitroisatin, acenaphthenequinone, benzil or 9,10-phenanthrenequinone. For example. the structural units of formula 5A can be:

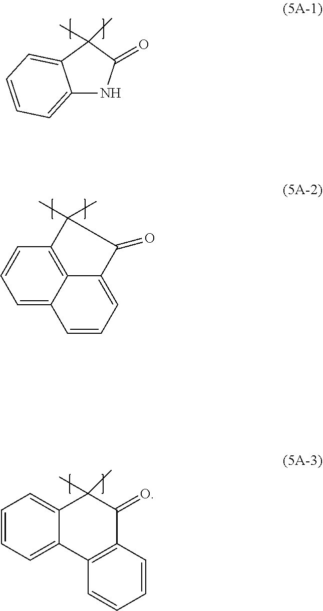

The diketone monomer has the formula:

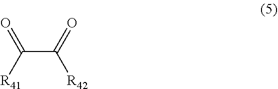

wherein R₄₁ and R₄₂ are each independently alkyl, alkenyl, alkynyl, amine or aryl, and the alkyl, alkenyl, alkynyl, amine or aryl are optionally substituted with halide or alkyl. R₄₁ and R₄₂ are optionally linked to form a five or six membered ring. When R₄₁ and R₄₂ are both aryl groups they are optionally fused to form a polycycle such as a naphthalene-type structure. Preferably, R₄₁ is aryl, and the aryl is optionally substituted with fluoride, such as phenyl substituted with fluoride; and R₄₂ is independently amine or aryl, and the aryl is optionally substituted with fluoride, such as phenyl substituted with fluoride. Preferably, the diketone monomer comprises isatin, 5-bromoisatin, 5-methylisatin, 5-nitroisatin, acenaphthenequinone, benzil or 9,10-phenanthrenequinone.

Representative polycycles of formula 5 include, but are not limited to:

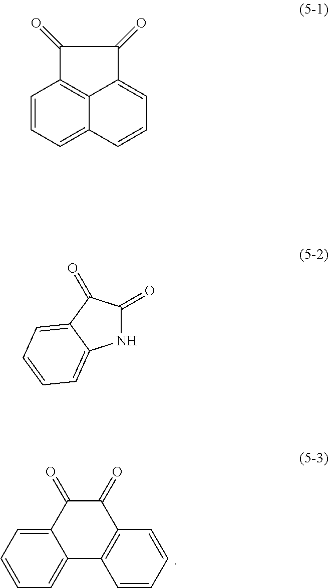 [SMILES: O=C1C(=O)c2cccc3cccc1c23 ; O=C1Nc2ccccc2C1=O ; O=C1C(=O)c2ccccc2-c2ccccc21]

The anion A⁻ of the structural units (1A), (1A-2) or (6A) or the monomer of formula (1-2) can comprise a halide, carbonate, bicarbonate, hydroxide, trifluoroacetate, acetate, triflate, methanesulfonate, sulfate, nitrate, tetrafluoroborate, hexafluorophosphate, formate, benzenesulfonate, toluate, perchlorate, or benzoate or any combination thereof.

A polymer is provided which comprises a reaction product of a mixture comprising the piperidone monomer, the other ketone monomer(s), the aromatic monomer and optionally the diketone monomer in the presence of an organic solvent and a polymerization catalyst. This polymer is referred to herein as an acidified polymer.

A polymer is provided which comprises a reaction product of a mixture comprising a base and a polymer comprising the reaction product of a polymerization mixture comprising the piperidone monomer. This polymer is referred to herein as a piperidine-functionalized polymer.

A polymer is provided which comprises a reaction product of a mixture comprising an alkylating reagent and a piperidine-functionalized polymer. This polymer is referred to herein as a piperidinium-functionalized polymer.

A polymer is provided which comprises a reaction product of a polymerization mixture comprising a quaternized piperidone monomer. This polymer is also referred to herein as a piperidinium-functionalized polymer.

A polymer is provided which comprises a reaction product of an ion exchange solution and a piperidinium-functionalized polymer.

A polymer is provided which comprises a reaction product of a hydroxide solution and a piperidinium-functionalized polymer. This polymer is referred to herein as a hydroxide exchange polymer.

A crosslinked anion exchange polymer or membrane can comprise the structural unit of formula (1A-2) wherein the anion A comprises a halide, tetrafluoroborate, hexafluorophosphate, bicarbonate, carbonate or hydroxide or a combination thereof.

A method of making an anion exchange polymer as described herein is provided. The method comprises: reacting the quaternized piperidone monomer with the aromatic monomer, the optional ketone monomer, the optional trifluoromethyl ketone and the optional diketone monomer in the presence of an organic solvent and a polymerization catalyst to form a piperidinium-functionalized polymer; and exchanging anions of the piperidinium-functionalized polymer with halide, hydroxide, bicarbonate, or carbonate ions or a combination thereof to form the anion exchange polymer.

Another method of making an anion exchange polymer as described herein is provided. The method comprises:
reacting the piperidone monomer with the aromatic monomer, the optional ketone monomer, the optional trifluoromethyl ketone and the optional diketone monomer in the presence of an organic solvent and a polymerization catalyst to form an acidified intermediate polymer;
reacting the acidified intermediate polymer with a base to form a piperidine-functionalized polymer;
alkylating the piperidine-functionalized intermediate polymer in the presence of an organic solvent to form a piperidinium-functionalized intermediate polymer; and
reacting the piperidinium-functionalized intermediate polymer with halide, hydroxide, bicarbonate, or carbonate ions or a combination thereof to form the anion exchange polymer.

For example, the monomers can be placed in a stirred container and dissolved or dispersed into an organic solvent. A polymerization catalyst in a solvent can then be added dropwise over up to 60 minutes at −78 to 60° C., such as from −78 to 0° C. Thereafter, the reaction is continued at this temperature for about 1 to about 120 hours. The resulting solution is poured slowly into an aqueous solution of an alcohol such as ethanol. The solid obtained is filtered, washed with water and immersed in 1 M a base such as K2CO3 at room temperature for about 1 to 48 hours. Finally, the product is filtered, washed with water and dried completely under vacuum to form the polymer. The polymer can then be subjected to anion exchange, for example in 1 M KOH for hydroxide exchange, at about 20 to 100° C. for about 12 to 48 hours, followed by washing and immersion in DI water for about 12 to 48 hours under an oxygen-free atmosphere to remove residual KOH.

Yet another method of making an anion exchange polymer as described herein is provided. The method comprises:

reacting the piperidone monomer with the aromatic monomer, the optional ketone monomer, the optional trifluoromethyl ketone and the optional diketone monomer in the presence of an organic solvent and a polymerization catalyst to form an acidified intermediate polymer;
reacting the acidified intermediate polymer with a base to form a neutral piperidine-functionalized polymer;
reacting the neutral piperidine-functionalized polymer with an alkylating agent to form a piperidinium-functionalized polymer;
exchanging anions of the piperidinium-functionalized polymer with hydroxide, bicarbonate, or carbonate ions or a combination thereof to form the anion exchange polymer;
dissolving the anion exchange polymer in a solvent to form a polymer suspension or solution; and
casting the polymer suspension or solution to form the anion exchange polymer membrane.

A method of making a crosslinked anion exchange polymer comprising the anion exchange polymer as described herein is provided. The method comprises:
reacting the piperidone monomer with the aromatic monomer, the optional ketone monomer, the optional trifluoromethyl ketone and the optional diketone monomer in the presence of an organic solvent and a polymerization catalyst to form an acidified polymer;
reacting the acidified polymer with a base to form a neutral piperidine-functionalized polymer;
partially quaternizing the neutral piperidine-functionalized polymer with an alkylating agent to form a partially quaternized piperidinium-functionalized polymer having piperidine groups available for crosslinking;
reacting the partially quaternized piperidinium-functionalized polymer with a crosslinking reagent to form a crosslinked polymer;
exchanging anions of the crosslinked polymer with halide, hydroxide, bicarbonate, or carbonate ions or a combination thereof to form the crosslinked anion exchange polymer; and
optionally reacting the crosslinked anion exchange polymer with trimethyl amine to quaternize partially reacted crosslinking reagent.

Another method of making a crosslinked anion exchange polymer comprising the anion exchange polymer as described herein is provided. The method comprises:
reacting the piperidone monomer with the aromatic monomer, the optional ketone monomer, the optional trifluoromethyl ketone and the optional diketone monomer in the presence of an organic solvent and a polymerization catalyst to form an acidified polymer;
reacting the acidified polymer with a base to form a neutral piperidine- functionalized polymer;
partially quaternizing the neutral piperidine-functionalized polymer with a crosslinking regent to form a crosslinked polymer;
reacting the crosslinked polymer with an alkylating agent to form a fully quaternized crosslinked polymer; and
exchanging anions of the polymer with halide, hydroxide, bicarbonate, or carbonate ions or a combination thereof to form the crosslinked anion exchange polymer.

Yet another method of making a crosslinked polymer membrane or a crosslinked anion exchange polymer membrane comprising the anion exchange polymer as described herein is provided. The method comprises:
reacting the piperidone monomer with the aromatic monomer, the optional ketone monomer, the optional trifluoromethyl ketone and the optional diketone monomer in the presence of an organic solvent and a polymerization catalyst to form an acidified polymer;
reacting the acidified polymer with a base to form a neutral piperidine-functionalized polymer;
reacting the neutral piperidine-functionalized polymer with an alkylating agent to form a piperidinium-functionalized polymer while leaving part of the neutral piperidine intact for crosslinking;
optionally exchanging anions of the piperidinium-functionalized polymer with hydroxide, bicarbonate, or carbonate ions or a combination thereof to form an anion exchange polymer membrane;
dissolving the piperidinium-functionalized polymer or the anion exchange polymer in a solvent to form a polymer suspension or solution;
adding a crosslinking reagent to the polymer suspension or solution and casting to form the crosslinked polymer membrane or the crosslinked anion exchange polymer membrane;
optionally reacting the crosslinked polymer membrane or the crosslinked anion exchange polymer membrane with trimethyl amine to quaternize partially reacted crosslinking reagent; and
optionally exchanging anions of the crosslinked polymer membrane or the crosslinked anion exchange polymer membrane with hydroxide, bicarbonate, or carbonate ions or a combination thereof.

The polymerization catalyst used in any of the methods described herein can comprise trifluoromethanesulfonic acid, pentafluoroethanesulfonic acid, heptafluoro-1-propanesulfonic acid, trifluoroacetic acid, perfluoropropionic acid, heptafluorobutyric acid, or a combination thereof.

Each of the organic solvents used in the any of the above methods can be independently selected from polar aprotic solvents (e.g., dimethyl sulfoxide, 1-methyl-2-pyrrolidone, dimethylacetamide, or dimethylformamide) or other suitable solvents including, but not limited to, methylene chloride, trifluoroacetic acid, trifluoromethanesulfonic acid, chloroform, 1,1,2,2-tetrachloroethane, dimethylacetamide or a combination thereof.

The solvent in the dissolving step of any of the above methods can comprise methanol, ethanol, n-propanol, isopropanol, n-butanol, sec-butanol, tert-butanol, a pentanol, a hexanol, dimethyl sulfoxide, 1-methyl-2-pyrrolidone, dimethylformamide, dimethylacetamide, chloroform, ethyl lactate, tetrahydrofuran, 2-methyltetrahydrofuran, water, phenol, acetone, or a combination thereof.

The crosslinking reagent used for casting the crosslinked membrane in the methods described herein can comprise 1,6-dibromohexane, 1,4-dibromobutane, 1,8-dibromooctane, 1,4-dibromohepane, 1,7-dibromohepane, 1,10-dibromodecane, 1,12-dibromododecane, 1,6-diiodohexane, 1,4-diiodobutane, 1,10-diiododecane, 1,5-diiodopentane, 1,8-diiodooctane, α,α′-dichloro-p-xylene, 4,4′-bis(chloromethyl)-1,1′-biphenyl, or any combination thereof.

The base used in any of the above methods can comprise a hydroxide-containing base such as sodium hydroxide or potassium hydroxide; a bicarbonate- containing base such as sodium bicarbonate or potassium bicarbonate; or a carbonate-containing base such as sodium carbonate or potassium carbonate.

The alkylating agent used in the any of the methods described herein can comprise methyl iodide, iodoethane, 1-iodopropane, 1-iodobutane, 1-iodopentane, 1-iodohexane, methyl bromide, bromoethane, 1-bromopropane, methyl chloride, chloroethane, 1-chloropropane, methyl fluorosulfonate, methyl trifluoromethanesulfonate, or a combination of thereof.

The alkylating agent used in the any of the methods described herein can comprise a quaternary ammonium or phosphonium group having the formula (6) or a combination of thereof.

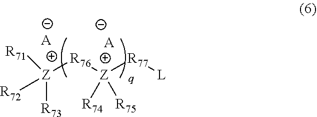

wherein: R₇₆ and R₇₇ are each independently alkylene; R₇₁, R₇₂, R₇₃, R₇₄ and R₇₅ are each independently alkyl, alkenyl, alkynyl or aryl; q is 0, 1, 2, 3, 4, 5 or 6; A⁻ is an anion; L is Cl, Br or I; and Z is N or P.

Preferably, R₇₆ and R₇₇ are each independently C₁-C₂₂ alkylene, such as C₁-C₆ alkylene (e.g. methylene, ethylene, n-propylene, n-pentylene or n-hexylene) or C₇-C₂₂ alkylene; R₇₁, R₇₂, R₇₃, R₇₄ and R₇₅ are each independently C₁-C₆ alkyl such as methyl, ethyl, n-propyl, n-butyl, isobutyl, tert-butyl, pentyl and hexyl; q is 0, 1, 2, 3, 4, 5, or 6; A is an anion such as a halide and Z is N. For example, the quaternary ammonium or phosphonium compound can have formula:

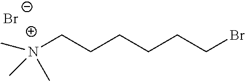

The alkylating agent used in the any of the methods described herein can comprise a nitrogen-containing heterocyclic group such as an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, caprolactam, or any combination thereof, wherein each substituent is independently alkyl, alkenyl, alkynyl, aryl, or aralkyl.

The nitrogen-containing heterocycle can comprise an imidazolium having the formula (7):

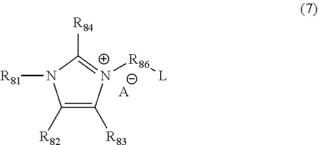

wherein: R₈₁, R₈₂, R₈₃, R₈₄ and R₈₆ are each independently optionally substituted alkyl, alkenyl, alkynyl, or aryl; L is Cl, Br or I; and A⁻is an anion. Preferably, R₈₄ is 2,4,6-alkylphenyl, and R₈₁, R₈₂, R₈₃ and R₈₆ are each independently C₁-C₆ alkyl, L is Br or I, A⁻ is a halide.

Preferably, the imidazolium compound has formula (7C):

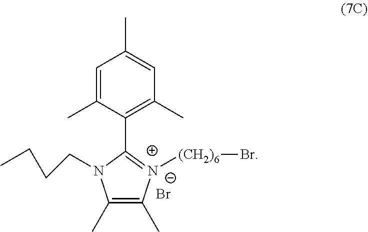

An anion exchange membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, and comprising any of the anion exchange polymers as described herein is provided.

A reinforced electrolyte membrane such as a reinforced anion exchange membrane is also provided to increase the mechanical robustness of the anion exchange membrane for stability through numerous wet and dry cycles. The reinforced membrane comprises a porous substrate impregnated with any of the anion exchange polymers as described herein. Methods for preparing reinforced membranes are well known to those of ordinary skill in the art such as those disclosed in U.S. Patent Nos. RE37,656 and RE37,701 , which are incorporated herein by reference for their description of reinforced membrane synthesis and materials.

A reinforced ion exchange membrane including any polymer membrane of the invention can be optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator.

The porous substrate of the reinforced electrolyte membrane can comprise a membrane comprised of polytetrafluoroethylene, polypropylene, polyethylene, poly(ether) ketone, polyaryletherketone, imidazole-tethered poly(aryl alkylene), imidazolium-tethered poly(aryl alkylene), polysulfone, perfluoroalkoxyalkane, or a fluorinated ethylene propylene polymer, and the membrane is optionally a dimensionally stable membrane.

The porous substrate of the reinforced electrolyte membrane can have at least one of the following:
the porous substrate has a porous microstructure of polymeric fibrils;
an interior volume of the porous substrate is rendered substantially occlusive by impregnation with the polymer;
the porous substrate comprises a microstructure of nodes interconnected by fibrils;
the porous substrate has a thickness from about 1 micron to about 100 microns;
the membrane is prepared by multiple impregnations of the substrate with the polymer; or
the membrane is prepared by: wetting the porous substrate in a liquid to form a wetted substrate; dissolving the polymer in a solvent to form a homogeneous solution or suspension;
applying the solution or suspension onto the wetted substrate to form the reinforced membrane; and drying the membrane.

The porous substrate can have a thickness from about 1 micron to about 10, 15, 20, 25, 30, 35, 40, 45, 50, 55, 60, 65, 70, 75, 80, 85, 90, 95 or 100 microns. Preferably, the porous substrate has a thickness from about 5 microns to about 30 microns, or from about 7 microns to about 20 microns.

### EXAMPLES

The following non-limiting examples are provided to further illustrate the present invention.

### Example 1

A non-crosslinked poly(aryl piperidinium) was prepared from N-methyl-4-piperidone, p-terphenyl, 4-acetylpyridine and optional 2,2,2-Trifluoroacetophenone. (referred to as P1-Me-x-a, wherein x is the mole ratio of N-methyl-4-piperidone to p-terphenyl and is from 0.01 to 0.99, a is the mole ratio of the quaternized 4-acetylpyridine to p-terphenyl and is from 0 to 0.99). P1-Me-x-a was prepared by three major steps: (1) synthesis of a piperidine-functionalized polymer, (2) synthesis of a piperidinium-functionalized polymer, and (3) membrane casting and hydroxide ion exchange. The reaction scheme is depicted below:

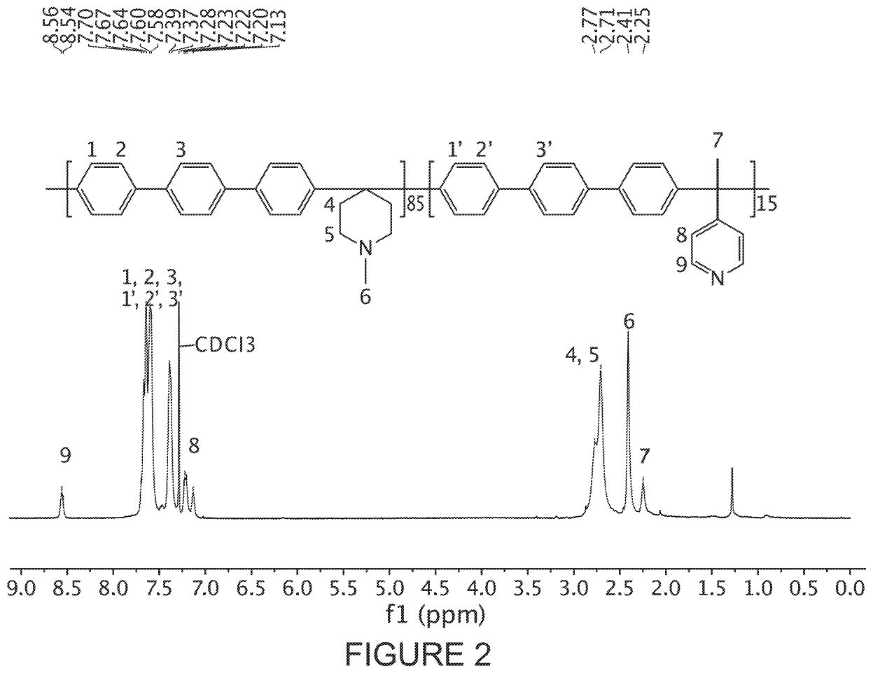

(1) Synthesis of a Piperidine-Functionalized Polymer, P1-Neutral-0.85 (i.e. x=0.85). To a 100 mL three-necked flask equipped with overhead a mechanical stirrer, N-methyl-4-piperidone (0.962 g, 8.5 mmol), 4-acetylpyridine (0.218 g, 1.8 mmol) and p-terphenyl (2.303 g, 10 mmol) were suspended into methylene chloride (9 mL). Trifluoromethanesulfonic acid (TFSA) (9 mL) were then added dropwise over 30 minutes at lower than −10° C. Thereafter, the reaction was continued at 0° C. temperature for 12 hours and then continued the reaction for another 24 h at 25° C. The resulting viscous solution was poured slowly into ethanol. The light yellow fibrous solid was filtered, washed with water and immersed in 1 M KOH at room temperature for 12 hours. Finally, the white fibrous product was filtered, washed with water and dried completely at 60° C. under vacuum. The yield of the polymer was nearly 100%. 1HNMR (0.7 ml CDCl3; δ, ppm): 8.55 (H9), 7.70-7.37 (H1, H2, H3, H1′, H2′ and H3′) 7.23-7.13 (H8), 2.77-2.71 (H4 and H5), and 2.41(H6), 2.25 (H7) (see FIG. 2).

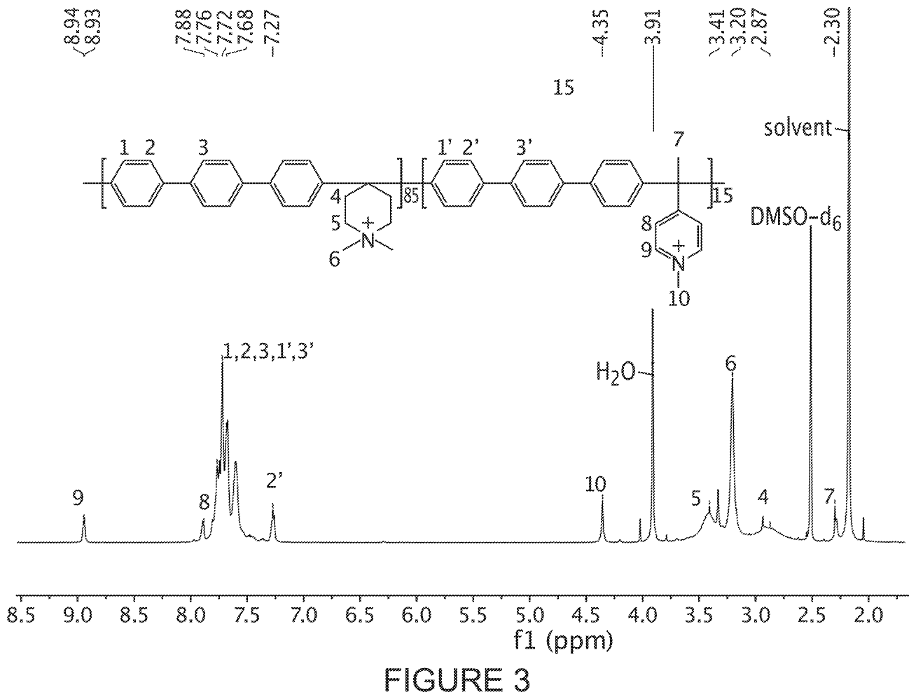

(2) Synthesis of Piperidinium-Functionalized Polymer, P1-Me-0.85-0.15 (i.e. x=0.85, a=0.15). To a 50 mL one-necked flask equipped with magnetic bar, piperidine-functionalized polymer (1.0 g) was dissolved into 1-methyl-2-pyrrolidinone (10 mL). Methyl iodide (0.5 mL) was added to the mixture quickly. The solution was stirred over 12 hours at room temperature. The resulting viscous, yellow solution was added dropwise into ether. The yellow solid was filtered, washed with ether and dried completely at 60° C. under vacuum. The yield of the polymer P1-Me-0.85-0.15 was almost 100%. 1HNMR (DMSO-d6; δ, ppm): 8.94 (H9), 7.88 (H8), 7.76-7.60 (H1, H2, H3, H1′and H3′), 7.27 (H2′), 4.35 (H10), 3.41 (H5), 3.20 (H6), 2.87 (H4), 2.30 (H7) (see FIG. 3).

(3) Membrane Casting and Hydroxide Exchange. A membrane was prepared by dissolving the P1-Me-0.85-0.15 polymer (1.0 g) in NMP (10 mL) and by casting on a clear glass plate at 80° C. for 8 hours. The membrane (in iodide form) was peeled off from the glass plate in contact with deionized (DI) water. The membrane in hydroxide form were obtained by ion exchange in 1 M KOH at 60° C. for 24 hours, followed by washing and immersing the membrane in DI water for 48 hours under argon to remove residual KOH.

Other P1-A-x-a membranes were prepared by using different mole ratios of N-methyl-4-piperidone and 4-acetylpyridine to p-terphenyl.

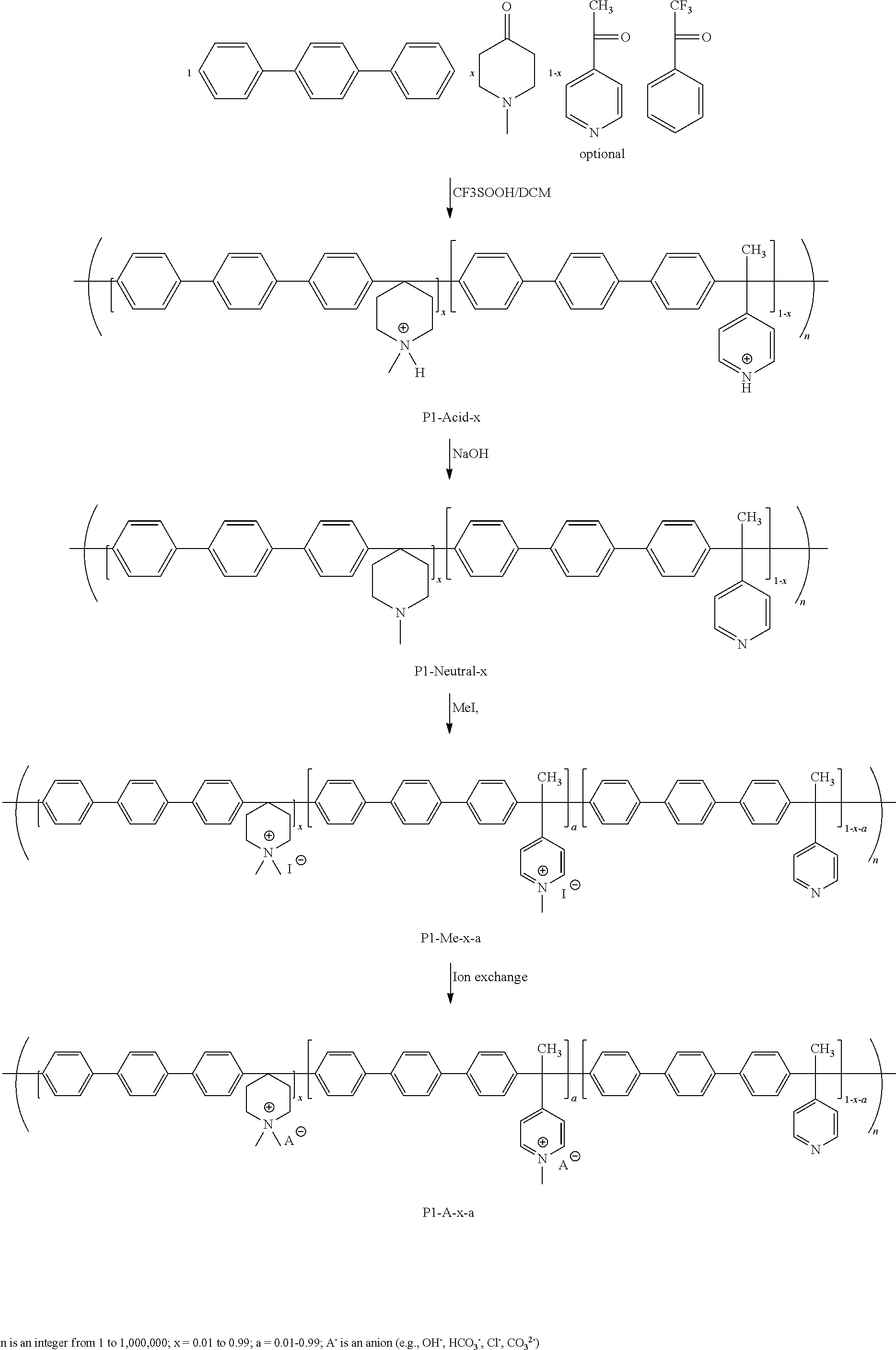

### Example 2

Crosslinked polymer based on the P1-Neutral-x piperidine-functionalized polymer.

A crosslinked poly(aryl piperidinium) was prepared from N-methyl-4-piperidone, p-terphenyl, 4-acetylpyridine and optional 2,2,2-Trifluoroacetophenone. (referred to as P1-Me-x(b)-XL-c, wherein x is the mole ratio of N-methyl-4-piperidone to p-terphenyl and is from 0.01 to 0.99, b is the mole ratio of the methyl iodide-quaternized piperidine to p-terphenyl and is from 0.01 to 0.99, c is the mole ratio of crosslinking reagent-quaternized piperidine to p-terphenyl and is from 0.01 to 0.99). P1-Me-x(b)-XL-c was prepared by three major steps: (1) synthesis of a piperidine-functionalized polymer, (2) synthesis of a partially quaternized piperidinium-functionalized polymer, and (3) membrane casting with a crosslinking reagent and hydroxide ion exchange. The reaction scheme is depicted below:

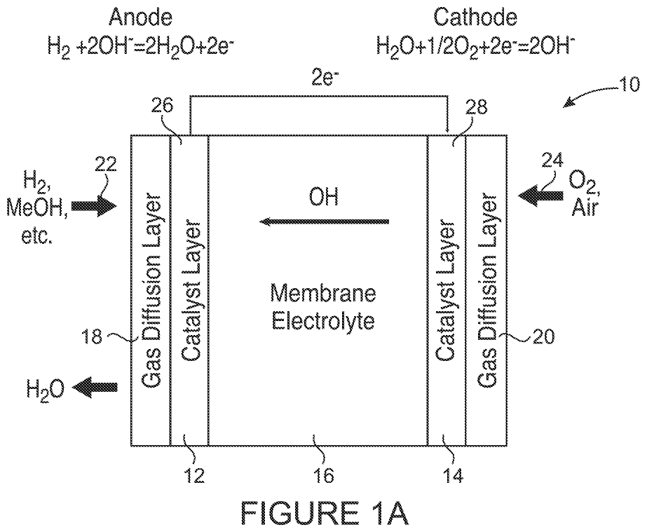

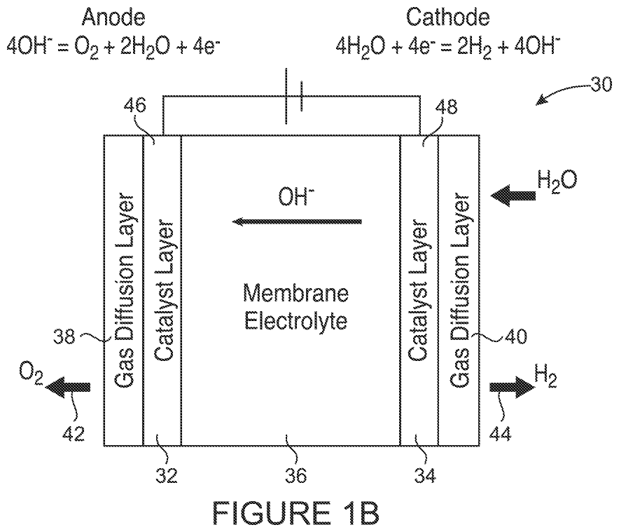

(1) Synthesis of a Piperidine-Functionalized Polymer, P1-Neutral-0.85 (i.e. x=0.85) To a 100 mL three-necked flask equipped with overhead a mechanical stirrer, N-methyl-4-piperidone (0.962 g, 8.5 mmol), 4-acetylpyridine (0.218 g, 1.8 mmol) and p-terphenyl (2.303 g, 10 mmol) were suspended into methylene chloride (9 mL). Trifluoromethanesulfonic acid (TFSA) (9 mL) were then added dropwise over 30 minutes at lower than −10° C. Thereafter, the reaction was continued at 0° C. temperature for 12 hours and then continued the reaction for another 24 h at 25° C. The resulting viscous solution was poured slowly into ethanol. The light yellow fibrous solid was filtered, washed with water and immersed in 1 M KOH at room temperature for 12 hours. Finally, the white fibrous product was filtered, washed with water and dried completely at 60° C. under vacuum. The yield of the polymer was nearly 100%. 1HNMR (0.7 ml CDCl3; δ, ppm): 8.55 (H9), 7.70-7.37 (H1, H2, H3, H1′, H2′ and H3′) 7.23-7.13 (H8), 2.77-2.71 (H4 and H5), and 2.41(H6), 2.25 (H7) (see FIG. 1).

(2) Synthesis of the partially quaternized Piperidinium-Functionalized Polymer, P1-Me-0.85(0.75) (i.e. x=0.85, b=0.75,) To a 50 mL one-necked flask equipped with magnetic bar, piperidine-functionalized polymer (1.0 g) was dissolved into 1-methyl-2-pyrrolidinone (10 mL). Methyl iodide (0.17 mL) was added to the mixture quickly to partially quaternized the piperidine. The solution was stirred over 12 hours at room temperature. The resulting viscous, yellow solution was added dropwise into ether. The yellow solid was filtered, washed with ether and dried completely at 60° C. under vacuum. The yield of the polymer P1-Me-0.85(0.75) was almost 100%.

(3) Membrane Casting and Hydroxide Exchange, P1-Me-0.85(0.75)-XL-0.10 (i.e. x=0.85, b=0.75, c=0.10) The crosslinked membrane was prepared by dissolving the P1-Me-0.85(0.75) polymer (1.0 g) and 1,6-dibromohexane (26.4 mg) in NMP (10 mL) and by casting on a clear glass plate at 80° C. for 8 hours. The membrane was peeled off from the glass plate in contact with deionized (DI) water. The membrane in hydroxide form were obtained by ion exchange in 1 M KOH at 60° C. for 24 hours, followed by washing and immersing the membrane in DI water for 48 hours under argon to remove residual KOH.

Other P1-Me-x(b)-XL-c membranes were prepared by using different mole ratios of N-methyl-4-piperidone, 4-acetylpyridine to p-terphenyl and different amount of methyl iodide and 1,6-dibromohexane.

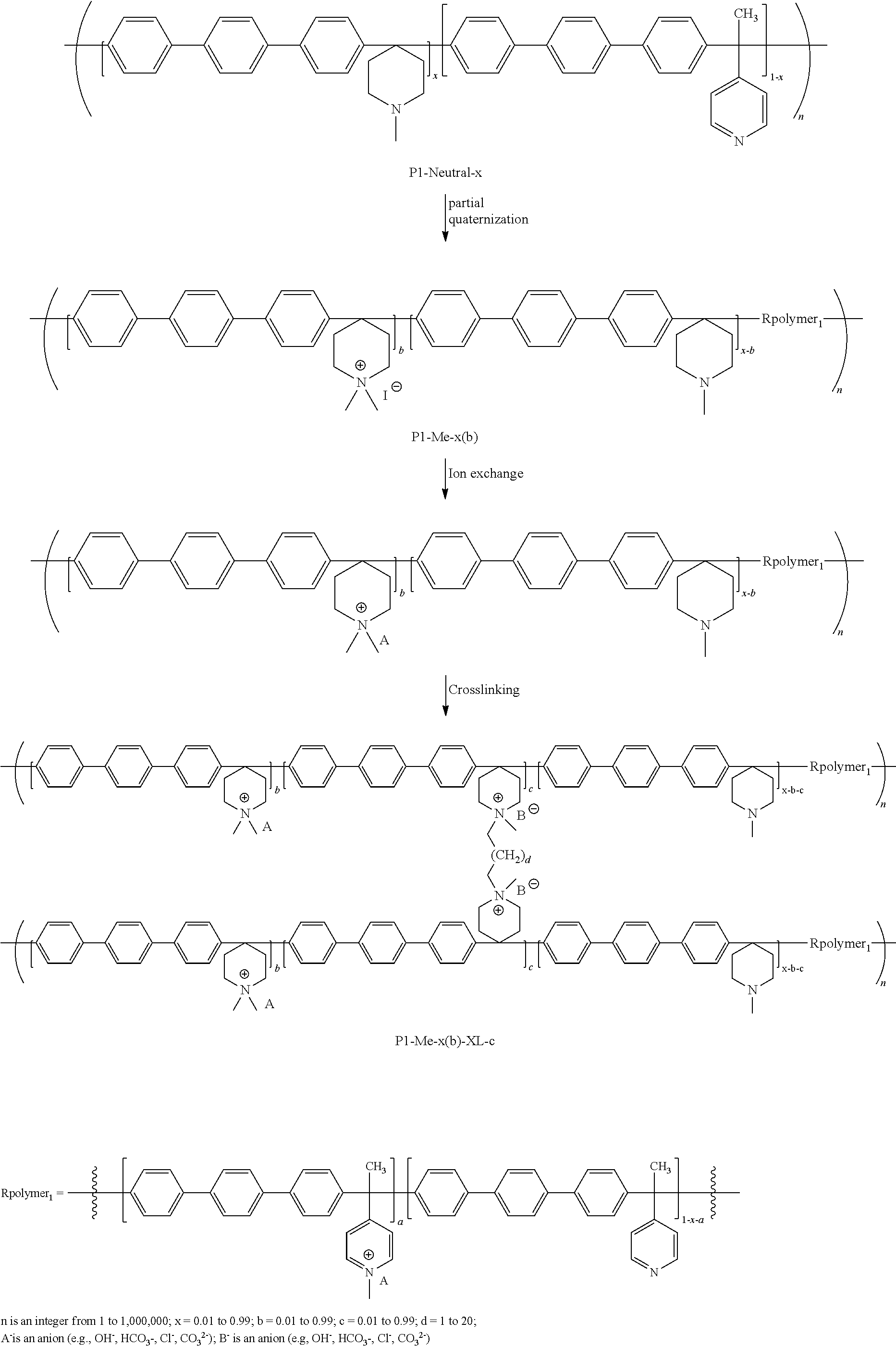

### Example 3

Polymers prepared from a mixture of piperidone, p-terphenvyl, 2,2,2-Trifluoroscatophenone. Isatin and optional 4-acetylpyridine monomers. The synthesis of the polymer is similar to the procedure described in example 1.

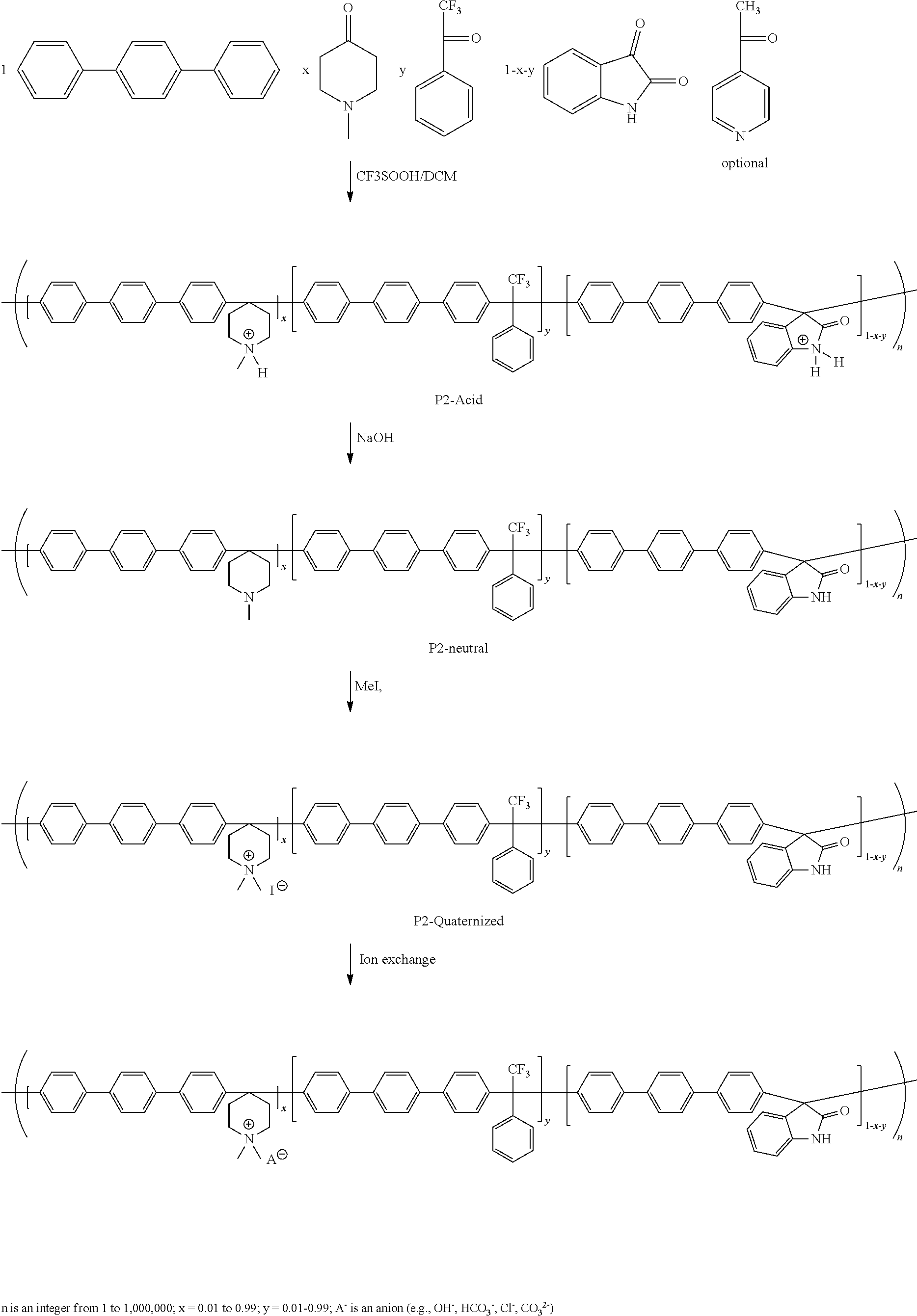

### Example 4

Crosslinked polymer based on the P2-Neutral piperidine-functionalized polymer. The synthesis of the polymer is similar to the procedure described in example 2.

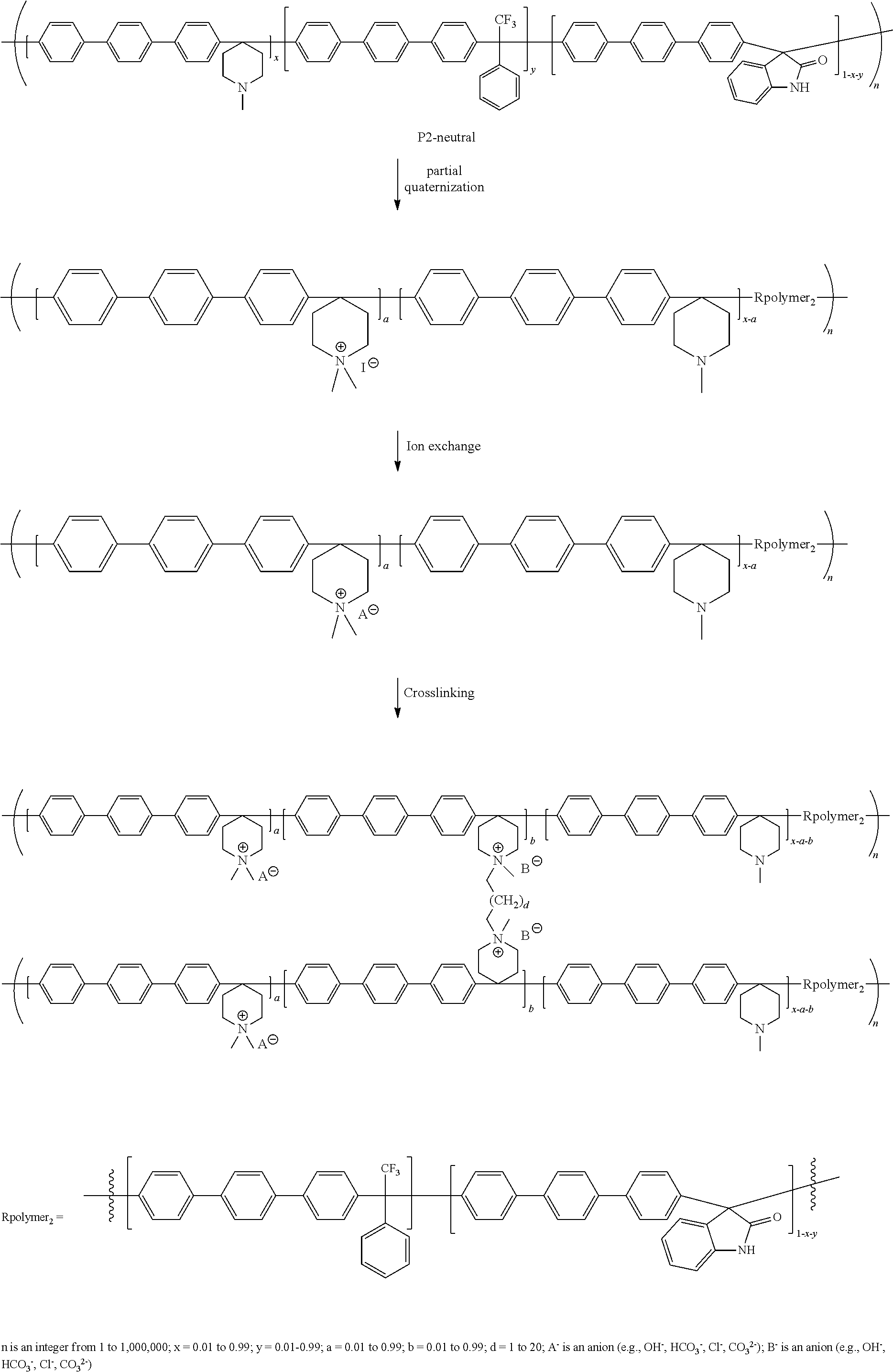

### Example 5

Polymers prepared from a mixture of piperidone, p-terphenyl, 4-acetylpyridine, Isatin and optional 2,2,2-Trifluoroacetophenone monomers. The synthesis of the polymer is similar to the procedure described in example 1.

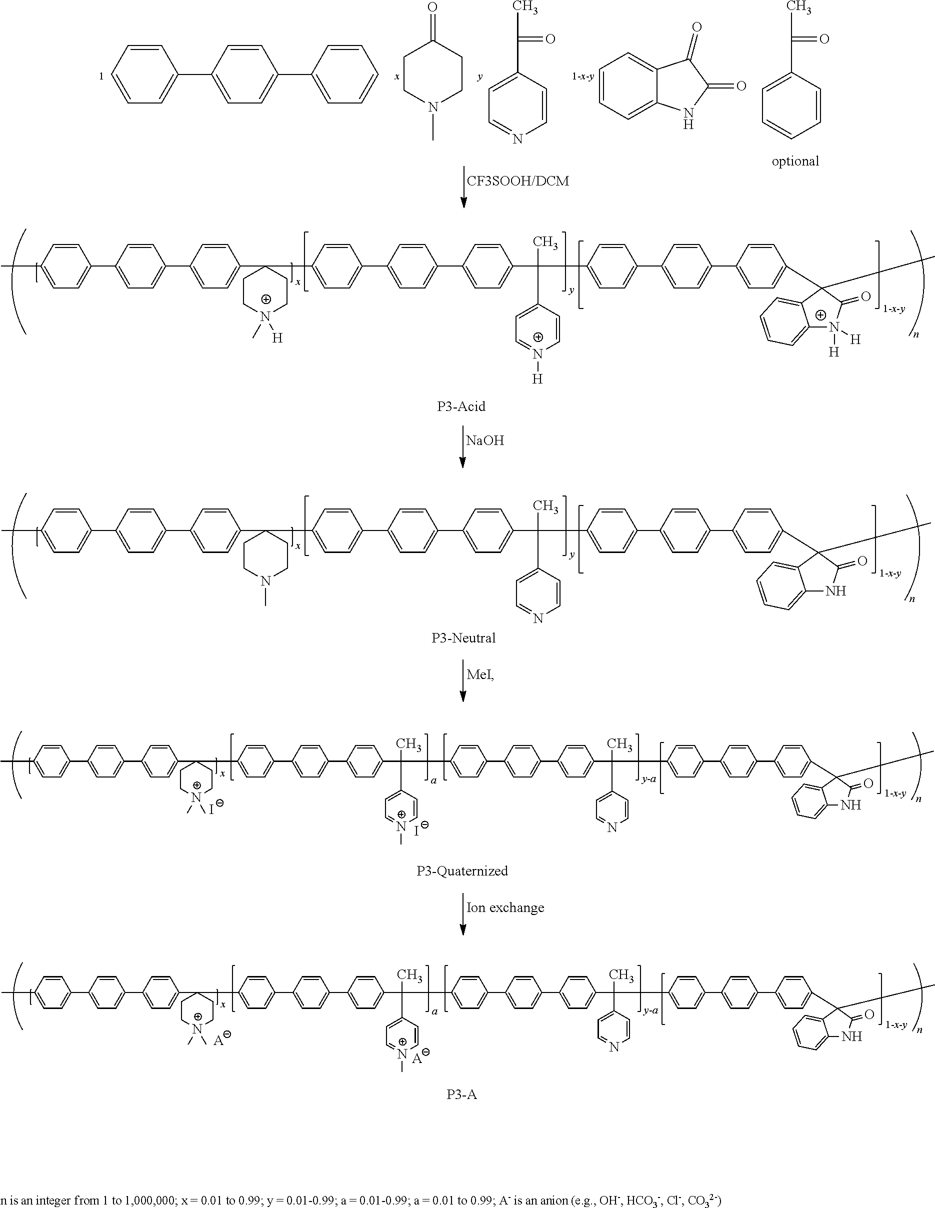

### Example 6

A crosslinked polymer based on the P3-Neutral piperidine-functionalized polymer. The synthesis of the polymer is similar to the procedure described in example 2.

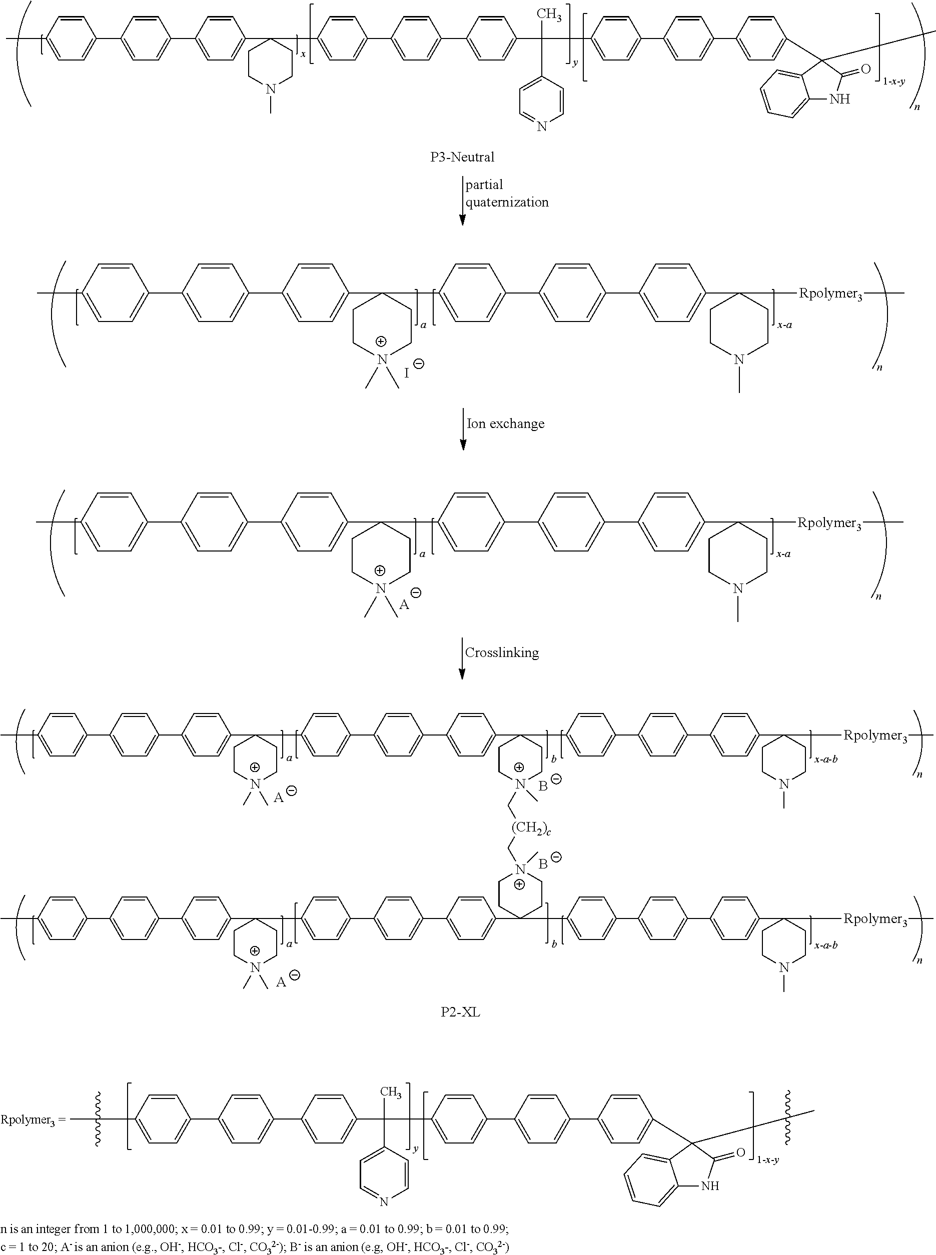

### Example 7

A non-crosslinked polymer prepared from a mixture of piperidone, p-terphenyl, optional 2,2,2-Trifluoroacetophenone and optional 4-acetylpyridine monomers. The synthesis of the polymer is similar to the procedure described in example 1

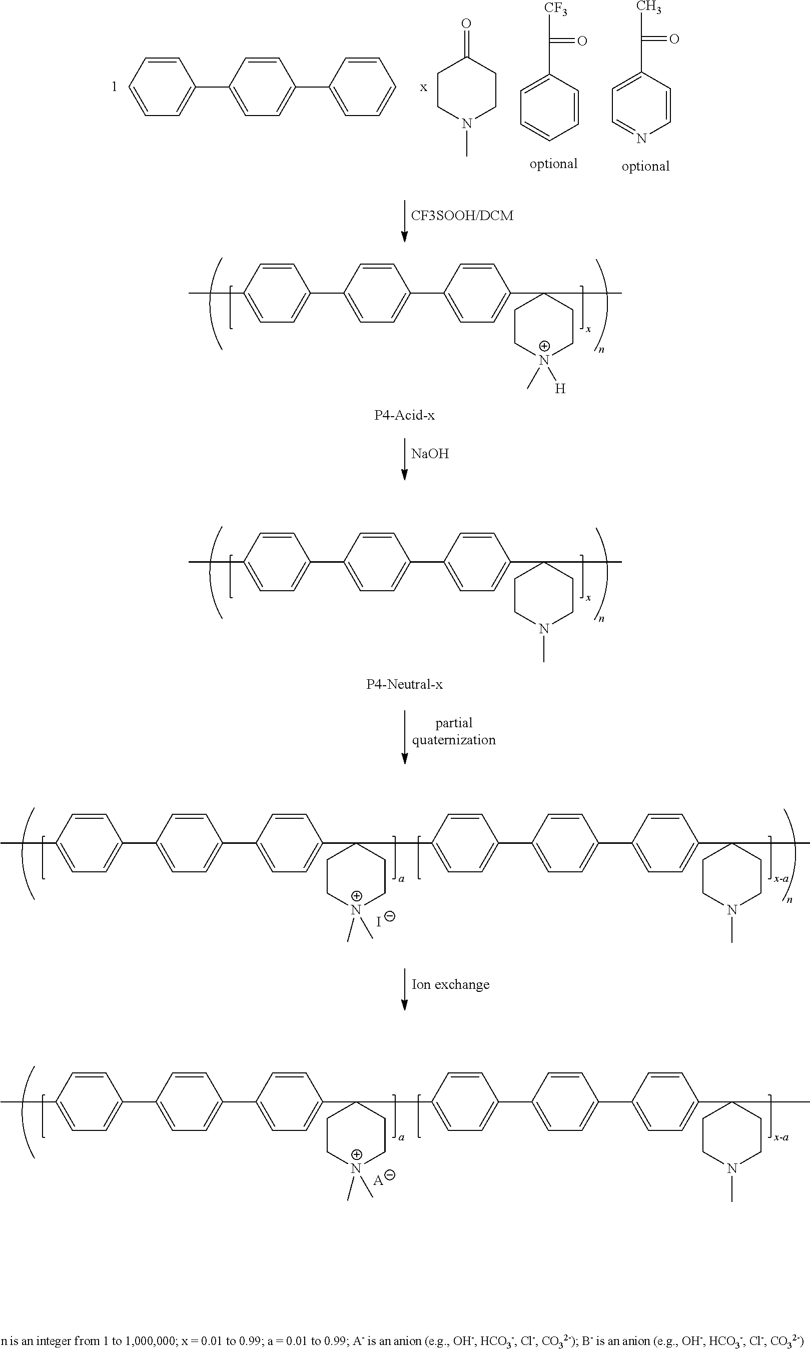

### Example 8

A crosslinked polymer prepared from a mixture of piperidone, p-terphenyl, optional 2,2,2-Trifluoroacetophenone and optional 4-acetylpyridine monomer. The synthesis of the polymer is similar to the procedure described in example 2.

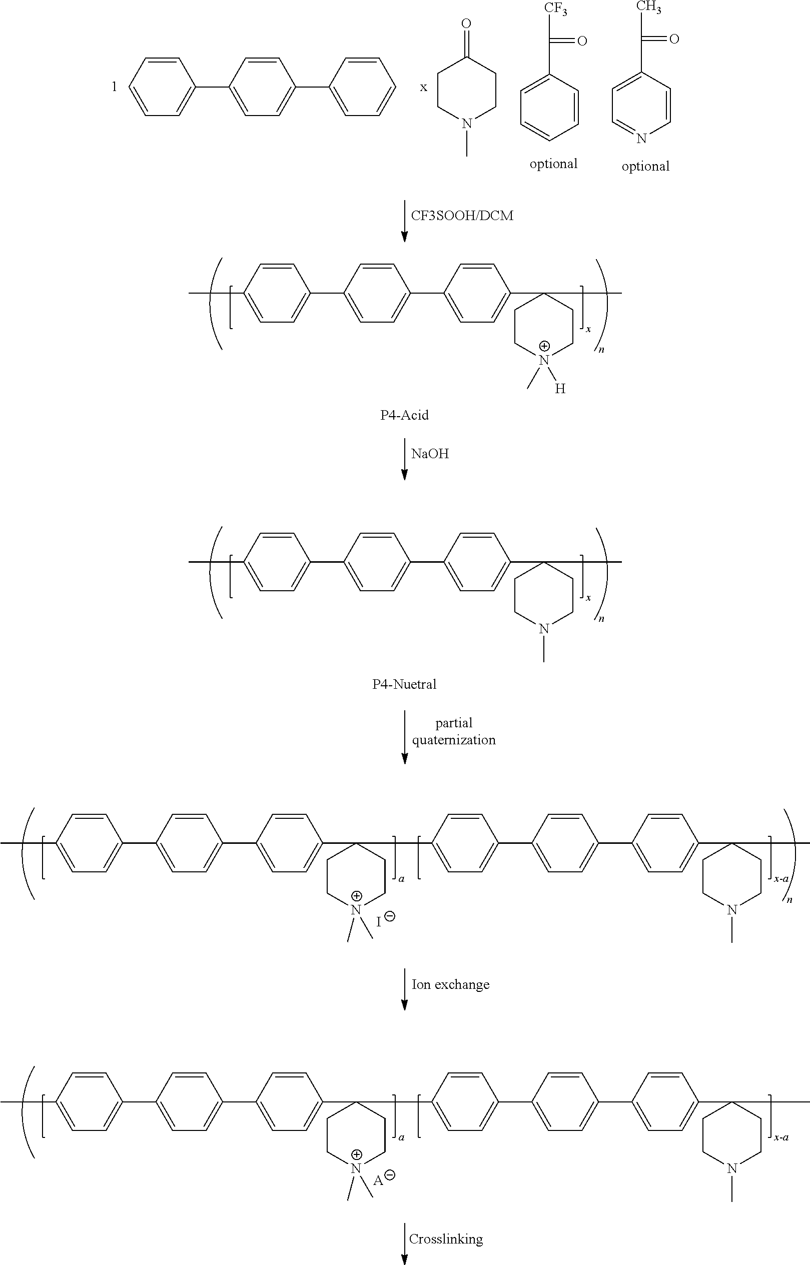

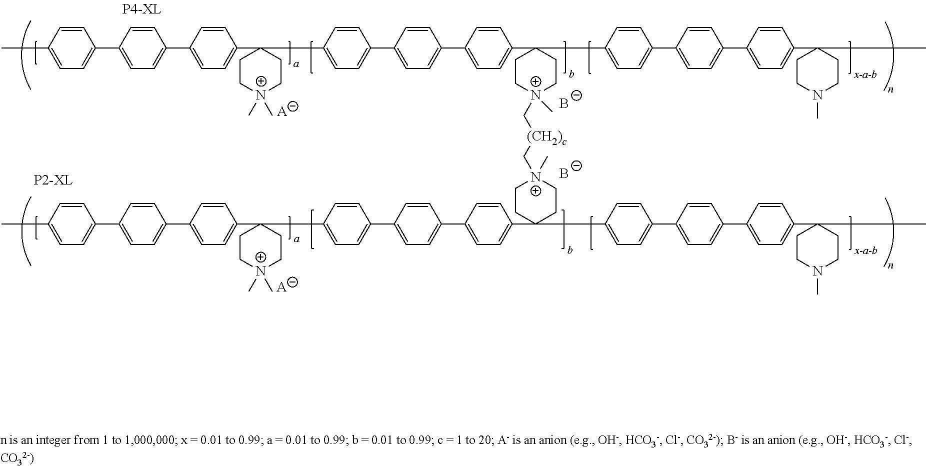

Crosslinked polymers, P4-1(0.85)-XL-(0.05), P4-1(0.85)-XL-(0.10), P4-1(0.85)-XL-(0.15), were prepared from P4-Neutral. The properties of the crosslinked polymers are summarized in the table below showing the decreased swelling ratio, decreased water uptake and increased conductivity with increased crosslinking.

| | | | | Conductivity |
|---|---|---|---|---|
| | | | | (OH—) |
| | | Water | Swelling | mS/cm |
| | IEC^{Cl—}, | uptake | ratio, | @ 80 C., |
| polymer membrane | mmol/g¹ | at 80 C.² | 80 C.² | 100% RH |
| P4-1(0.85)-XL-(0) | 2.45 | 83% | 14% | 212 |
| P4-1(0.85)-XL-(0.11) | 2.67 | 65% | 11% | 235 |
| P4-1(0.85)-XL-(0.15) | 2.81 | 42% | 7% | 264 |

¹IEC was obtained with titration of the chloride form membrane
²Membrane was in bicarbonate form

### Example 9

A non-crosslinked polymer prepared from a mixture of piperidone, p-terphenyl, 4-acetylpyridine and optional 2,2,2-Trifluoroacetophenone. The synthesis of the polymer is similar to the procedure described in example 1.

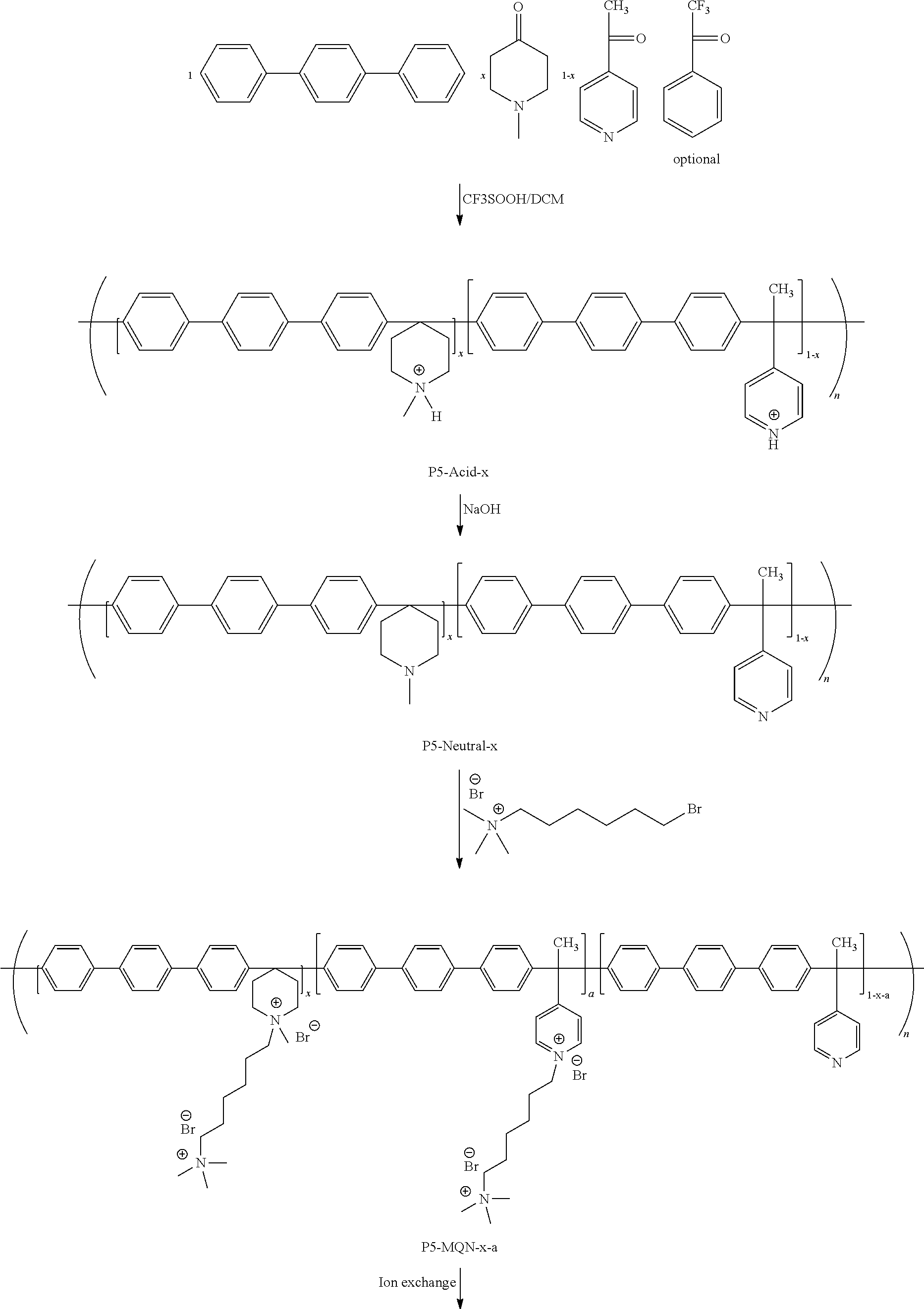

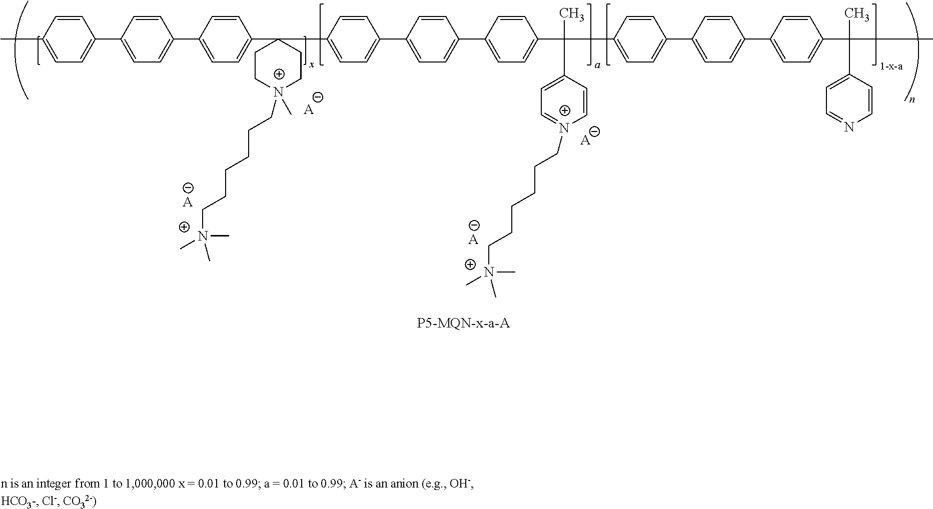

### Example 10

A crosslinked polymer prepared from P5-Neutral-x. The synthesis of the polymer is similar to the procedure described in example 2.

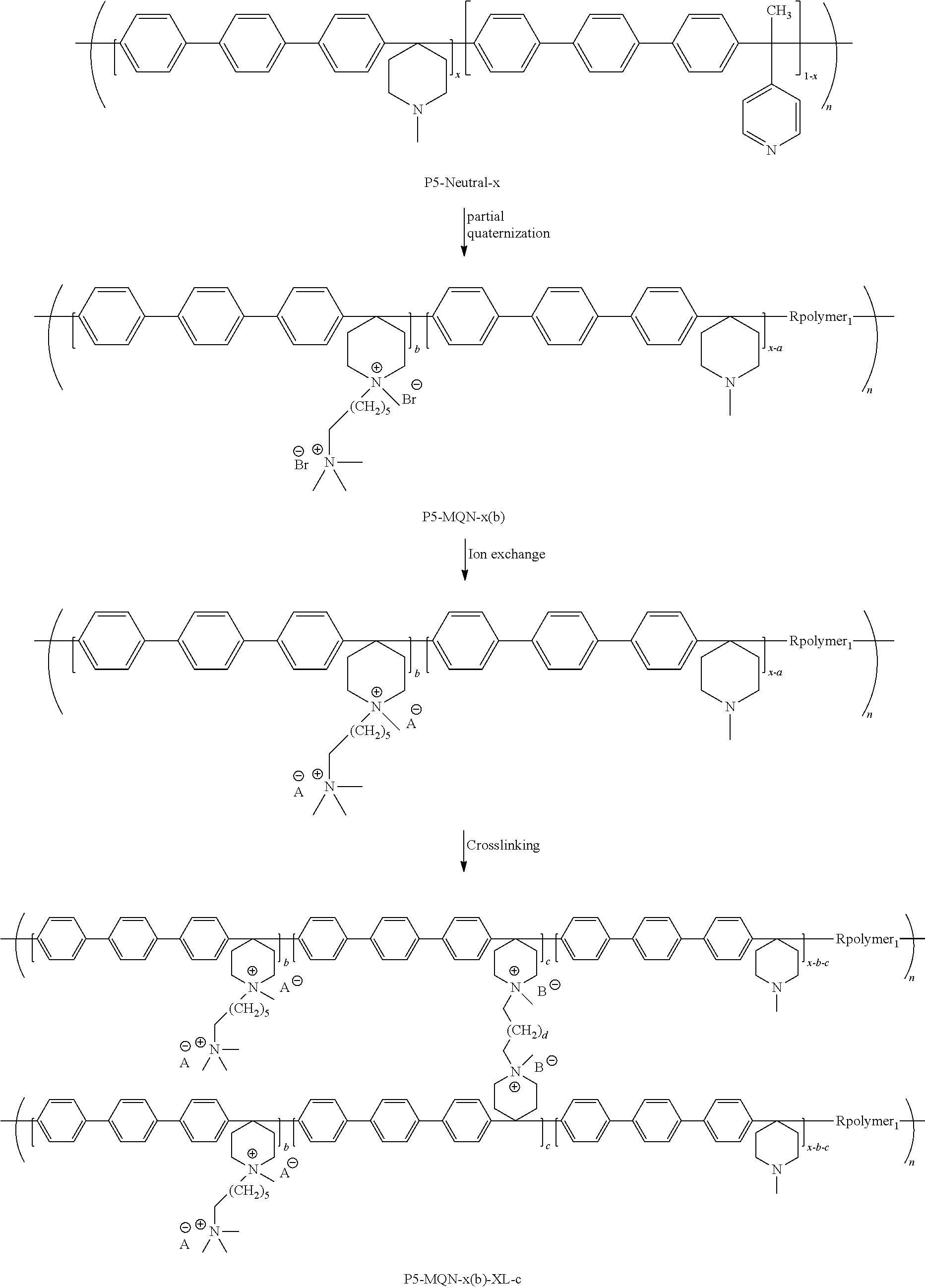

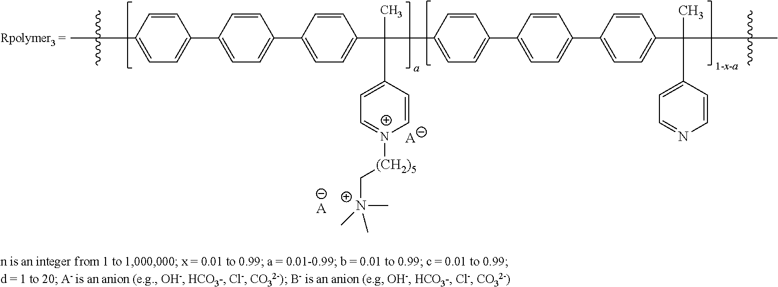

### Example 11

A crosslinked polymer prepared from a mixture of piperidone, p-biphenyl, and optional 2,2,2-Trifluoroacetophenone. The synthesis of the polymer is similar to the procedure described in example 1.

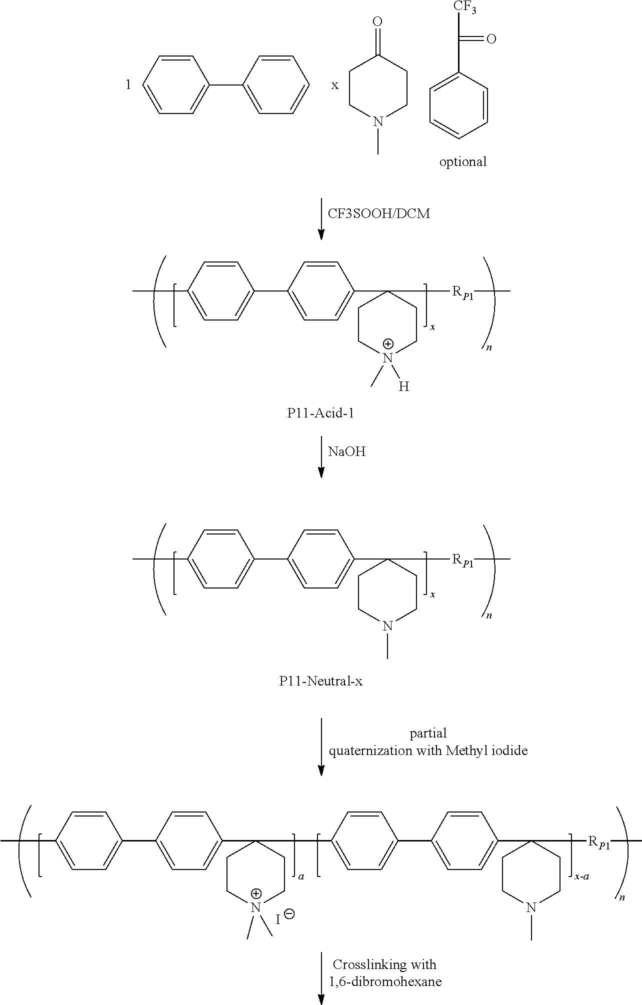

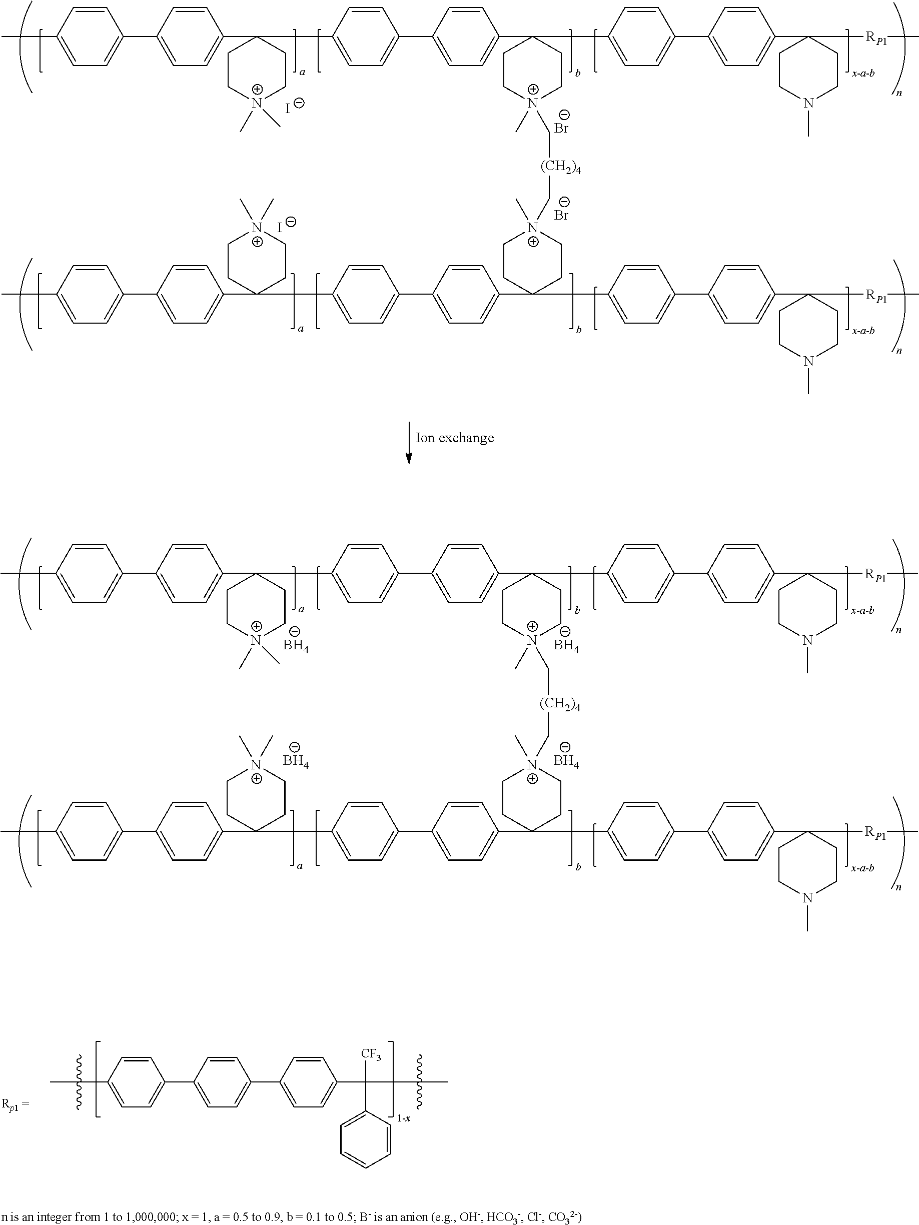

Crosslinked polymers, P11-1(0.76)-XL-(0), P11-1(0.76)-XL-(0.1), P11-1(0.76)-XL-(0.25), having 0, 10% and 25% degree of crosslinking, respectively, were prepared from P11-Neutral-x. The properties of the crosslinked polymers are summarized in the table below showing the decreased swelling ratio, decreased water uptake and increased conductivity with increased crosslinking.

| | | | | Conductivity |
|---|---|---|---|---|
| | | | | (OH—) |
| | | Water | Swelling | mS/cm |
| | IEC^{Cl—}, | uptake | ratio, | @ 80 C., |
| polymer membrane | mmol/g¹ | at 80 C.² | 80 C.² | 100% RH |
| P11-1(0.76)-XL-(0) | 2.2 | 459% | 48% | 200 |
| P11-1(0.76)-XL-(0.1) | 2.4 | 226% | 26% | 220 |
| P11-1(0.76)-XL-(0.25) | 2.6 | 190% | 23% | 270 |

¹IEC was obtained with titration of the chloride form membrane
²Membrane was in bicarbonate form

### DEFINITIONS

The term “suitable substituent,” as used herein, is intended to mean a chemically acceptable functional group, preferably a moiety that does not negate the activity of the inventive compounds. Such suitable substituents include, but are not limited to halo groups, perfluoroalkyl groups, perfluoroalkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl—and dialkylamino groups, carbamoyl groups, alkylcarbonyl groups, alkoxycarbonyl groups, alkylaminocarbonyl groups, dialkylamino carbonyl groups, arylcarbonyl groups, aryloxycarbonyl groups, alkylsulfonyl groups, and arylsulfonyl groups. Those skilled in the art will appreciate that many substituents can be substituted by additional substituents.

The term “alkyl,” as used herein, refers to a linear, branched or cyclic hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons), and more preferably having 1 to 18 carbon atoms. Alkyl groups include, but are not limited to, methyl, ethyl, n-propyl, isopropyl, n-butyl, iso-butyl, secondary-butyl, and tertiary-butyl. Alkyl groups can be unsubstituted or substituted by one or more suitable substituents.

The term “alkenyl,” as used herein, refers to a straight, branched or cyclic hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, more preferably having 1 to 18 carbon atoms, and having one or more carbon-carbon double bonds. Alkenyl groups include, but are not limited to, ethenyl, 1-propenyl, 2-propenyl (allyl), iso-propenyl, 2-methyl-1-propenyl, 1-butenyl, and 2-butenyl. Alkenyl groups can be unsubstituted or substituted by one or more suitable substituents, as defined above.

The term “alkynyl,” as used herein, refers to a straight, branched or cyclic hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, more preferably having 1 to 18 carbon atoms, and having one or more carbon-carbon triple bonds. Alkynyl groups include, but are not limited to, ethynyl, propynyl, and butynyl. Alkynyl groups can be unsubstituted or substituted by one or more suitable substituents, as defined above.

The term “aryl” or “ar,” as used herein alone or as part of another group (e.g., aralkyl), means monocyclic, bicyclic, or tricyclic aromatic radicals such as phenyl, naphthyl, tetrahydronaphthyl, indanyl and the like; optionally substituted by one or more suitable substituents, preferably 1 to 5 suitable substituents, as defined above. The term “aryl” also includes heteroaryl.

Arylalkyl” or “aralkyl” means an aryl group attached to the parent molecule through an alkylene group. The number of carbon atoms in the aryl group and the alkylene group is selected such that there is a total of about 6 to about 18 carbon atoms in the arylalkyl group. A preferred arylalkyl group is benzyl.

The term “cycloalkyl,” as used herein, refers to a mono, bicyclic or tricyclic carbocyclic radical (e.g., cyclopropyl, cyclobutyl, cyclopentyl, cyclohexyl, cycloheptyl, cyclooctyl, cyclononyl, cyclopentenyl, cyclohexenyl, bicyclo[2.2.1]heptanyl, bicyclo[3.2.1 ]octanyl and bicyclo[5.2.0]nonanyl, etc.); optionally containing 1 or 2 double bonds. Cycloalkyl groups can be unsubstituted or substituted by one or more suitable substituents, preferably 1 to 5 suitable substituents, as defined above.

The term “-ene” as used as a suffix as part of another group denotes a bivalent radical in which a hydrogen atom is removed from each of two terminal carbons of the group, or if the group is cyclic, from each of two different carbon atoms in the ring. For example, alkylene denotes a bivalent alkyl group such as ethylene (—CH₂CH₂—) or isopropylene (—CH(CH₃)CH₂—). For clarity, addition of the -ene suffix is not intended to alter the definition of the principal word other than denoting a bivalent radical. Thus, continuing the example above, alkylene denotes an optionally substituted linear saturated bivalent hydrocarbon radical.

The term “hydrocarbon” as used herein describes a compound or radical consisting exclusively of the elements carbon and hydrogen.

The term “polycycle” as used herein describes a compound or radical having two or more hydrocarbon rings which can be substituted with heteroatom(s) such as nitrogen or oxygen. The polycycle can be aromatic or non-aromatic.

The term “substituted” means that in the group in question, at least one hydrogen atom bound to a carbon atom is replaced with one or more substituent groups such as hydroxy (—OH), alkylthio, phosphino, amido (—CON(RA)(RB), wherein RA and RB are independently hydrogen, alkyl, or aryl), amino(—N(RA)(RB), wherein RA and RB are independently hydrogen, alkyl, or aryl), halo (fluoro, chloro, bromo, or iodo), silyl, nitro (-NO2), an ether (-ORA wherein RA is alkyl or aryl), an ester (—OC(O)RA wherein RA is alkyl or aryl), keto (—(O)RA wherein RA is alkyl or aryl), heterocyclo, and the like. When the term “substituted” introduces or follows a list of possible substituted groups, it is intended that the term apply to every member of that group. That is, the phrase “optionally substituted alkyl or aryl” is to be interpreted as “optionally substituted alkyl or optionally substituted aryl.” Likewise, the phrase “alkyl or aryl optionally substituted with fluoride” is to be interpreted as “alkyl optionally substituted with fluoride or aryl optionally substituted with fluoride.”

The term “tethered” means that the group in question is bound to the specified polymer backbone. For example, an imidazolium-tethered poly (aryl alkylene) polymer is a polymer having imidazolium groups bound to a poly (aryl alkylene) polymer backbone.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved, and other advantageous results attained.

As various changes could be made in the above products and methods without departing from the scope of the invention, it is intended that all matter contained in the above description and shown in the accompanying drawings shall be interpreted as illustrative and not in a limiting sense.

1. An anion exchange polymer comprising:
structural units of formulae 1A, 2A, 3A, optionally 1A-2, and optionally 4A; or structural units of formulae 1A, 1A-2, 3A, and optionally 4A; and
wherein:
a sum of mole fractions of the structural units of formulae 1A, 1A-2, 2A and 4A is equal to a mole fraction of formula 3A in the polymer calculated from an amount of monomers used in a polymerization reaction to form the polymer, and a mole ratio of the structural unit of Formula 1A or 1A-2 or 2A or 4A to the structural unit of Formula 3A is from 0.01 to 1 calculated from the amount of monomers used in the polymerization reaction; and
the structural units of Formulae 1A, 1A-2, 2A, 3A, and 4A have the structures: 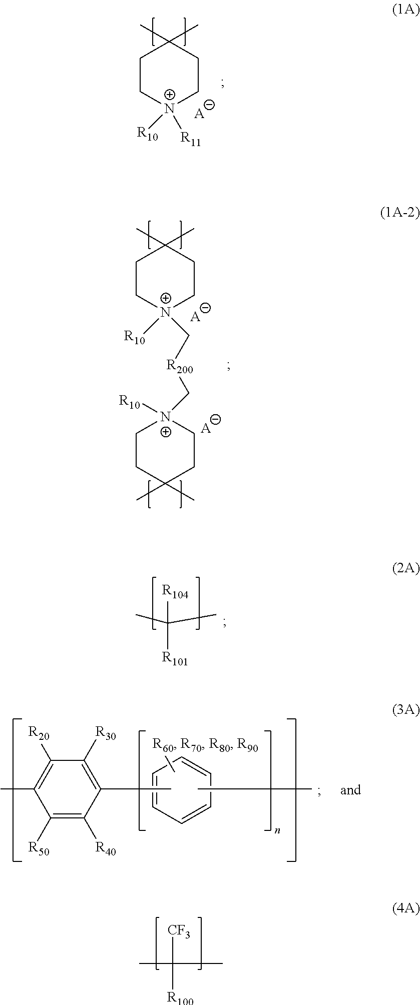
wherein:
A⁻ is an anion;
n is 0, 1, 2 or 3;
q is 0, 1, 2, 3, 4, 5 or 6;
R₁₀ and R₁₁ are each independently hydrogen, alkyl, alkenyl, alkynyl, aryl, a nitrogen-containing heterocyclic group, or a quaternary ammonium or phosphonium group having the formula (6A), the alkyl, alkenyl, alkynyl or aryl being optionally substituted with halide 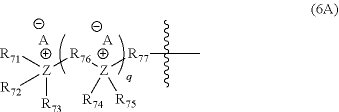
and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₀, R₂₁, R₂₂, R₂₃, R₂₄, R₂₅, R₂₆, R₂₇, R₂₈, R₂₉, R₃₀, R₄₀, R₅₀, R₆₀, R₇₀, R₈₀, R₉₀, R₁₀₄, R₁₃₀, R₁₄₀, R₁₅₀, R₁₆₀, and R₁₇₀ are each independently hydrogen, halide, alkyl, alkenyl, alkynyl or aryl, and the alkyl, alkenyl, alkynyl or aryl are optionally substituted with halide, and wherein R₃₀ and R₆₀ are optionally linked to form a five membered ring optionally substituted with halide or alkyl;
R₇₁, R₇₂, R_{73,} R₇₄ and R₇₅ are each independently alkyl, alkenyl, alkynyl or aryl;
R₇₆ and R₇₇ are each independently alkylene;
each R₁₀₀ is independently alkyl, alkenyl, alkynyl, or 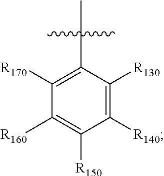
each R₁₀₁ is independently 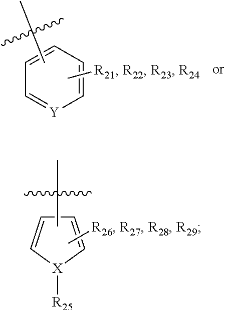
each R₂₀₀ is independently alkylene, arylene, alkenylene, or alkynylene;
X is N, S or O;
Y is C or N; and
Z is N or P.

2. An anion exchange polymer comprising a reaction product of a polymerization mixture comprising:
a piperidone monomer or salt or hydrate thereof of formula 1, a ketone monomer of formula 2, an aromatic monomer of formula 3, optionally a trifluoromethyl ketone monomer of formula 4, and optionally a quaternized piperidone of formula 1-2; or the piperidone monomer of formula 1, the quaternized piperidone of formula 1-2, the aromatic monomer of formula 3, and optionally the trifluoromethyl ketone monomer of formula 4; and
wherein:
(i) a piperidone monomer or salt or hydrate thereof has the formula: 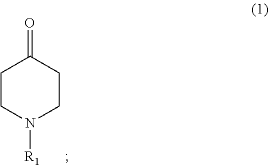
or
(ii) a quaternized piperidone has the formula: 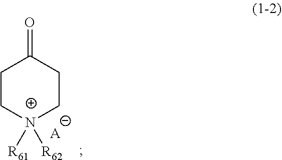
(iii) a ketone monomer has the formula: 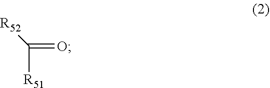
(iv) an aromatic monomer has the formula: 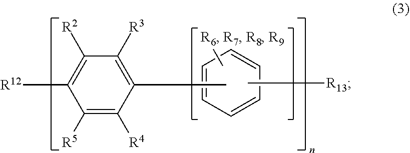
and
(v) a trifluoromethyl ketone monomer has the formula: 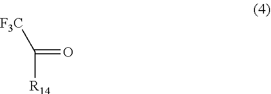
wherein:
A⁻ is an anion;
n is 0, 1, 2 or 3;
R₁,l R₂, R₃, R₄, R₅, R₆, R₇, R₈, R₉, R₁₂, R₁₃, R₁₅, R₁₆, R₁₇, R₁₈, R₁₉, R₃₁, R₃₂, R₃₃, R₃₄, R₃₅, R₃₆, R₃₇, R₃₈, R₃₉, R₅₂, R₆₁ and R₆₂ are each independently hydrogen, halide, alkyl, alkenyl, alkynyl or aryl, and the alkyl, alkenyl, alkynyl or aryl are optionally substituted with halide, and wherein R₃ and R₆ are optionally linked to form a five membered ring optionally substituted with halide or alkyl;
each R₁₄ is independently alkyl, alkenyl, alkynyl, or 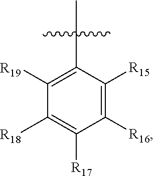
and the alkyl, alkenyl, or alkynyl are optionally substituted with fluoride;
each R₅₁ is independently 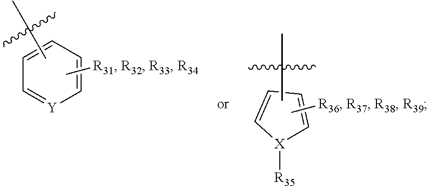
X is N, S or O; and
Y is C or N.

3. An anion exchange polymer comprising:
structural units of formulae 1A, 3A, 4A, 5A, optionally 1A-2, and optionally 2A; or structural units of formulae 1A, 2A, 3A, 5A, optionally 1A-2 and optionally 4A; and
wherein:
a sum of mole fractions of the structural units of formulae 1A, 1A-2, 2A, 4A and 5A is equal to a mole fraction of formulae 3A in the polymer calculated from amounts of monomers used in a polymerization reaction to form the polymer, and a mole ratio of the structural unit of formula 1A or 1A-2 or 4A or 5A to the structural unit of formula 3A is from 0.01 to 1 calculated from the amounts of the monomers used in the polymerization reaction; and
the structural units of formulae 1A, 1A-2, 2A, 3A, 4A and 5A have the structures: 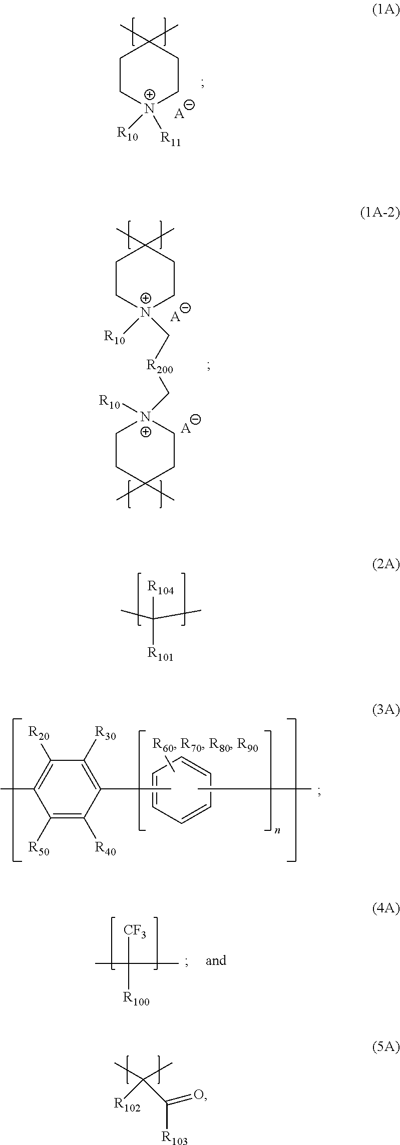
wherein:
A⁻ is an anion;
n is 0, 1, 2 or 3;
q is 0, 1, 2, 3, 4, 5 or 6;
R₁₀ and R₁₁ are each independently hydrogen, alkyl, alkenyl, alkynyl, aryl, a nitrogen-containing heterocyclic group, or a quaternary ammonium or phosphonium group having the formula (6A), the alkyl, alkenyl, alkynyl or aryl being optionally substituted with halide 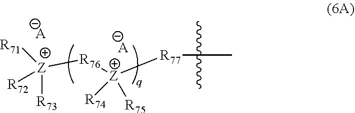
and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₀, R₂₁, R₂₂, R₂₃, R₂₄, R₂₅, R₂₆, R₂₇, R₂₈, R₂₉, R₃₀, R₄₀, R₅₀, R₆₀, R₇₀, R₈₀, R₉₀, R₁₀₄, R₁₃₀, R₁₄₀, R₁₅₀, R₁₆₀, and R₁₇₀ are each independently hydrogen, halide, alkyl, alkenyl, alkynyl or aryl, and the alkyl, alkenyl, alkynyl or aryl are optionally substituted with halide, and wherein R₃₀ and R₆₀ are optionally linked to form a five membered ring optionally substituted with halide or alkyl;
R₇₁, R₇₂, R₇₃, R₇₄ and R₇₅ are each independently alkyl, alkenyl, alkynyl or aryl;
R₇₆ and R₇₇ are each independently alkylene;
each R₁₀₀ is independently alkyl, alkenyl, alkynyl, or 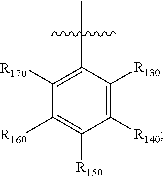
each R₁₀₁ is independently 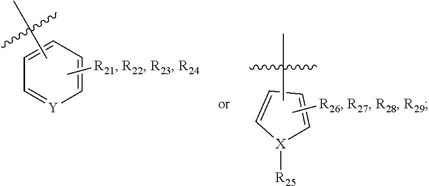
R₁₀₂ and R₁₀₃ are each independently alkyl, alkenyl, alkynyl, amine or aryl, and the alkyl, alkenyl, alkynyl, amine or aryl are optionally substituted with halide or alkyl, and wherein R₁₀₂ and R₁₀₃ are optionally linked to form a five or six membered ring or a polycycle;
each R₂₀₀ is independently alkylene, arylene, alkenylene, or alkynylene;
X is N, S or O;
Y is C or N; and
Z is N or P.

4. An anion exchange polymer comprising a reaction product of a polymerization mixture comprising:
a piperidone monomer or salt or hydrate thereof of formula 1, an aromatic monomer of formula 3, a trifluoromethyl ketone monomer of formula 4, a diketone monomer of formula 5, optionally a quaternized piperidone of formula 1-2 and optionally a ketone monomer of formula 2; or
the piperidone monomer of formula 1, the ketone monomer of formula 2, the aromatic monomer of formula 3, the diketone monomer of formula 5, optionally the quaternized piperidone of formula 1-2 and optionally the trifluoromethyl ketone monomer of formula 4; and
wherein:
(i) the piperidone monomer or salt or hydrate thereof has the formula: 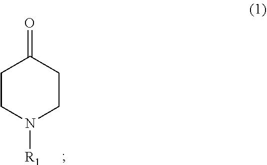
(ii) the quaternized piperidone has the formula; 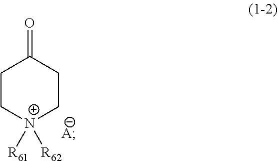
(iii) the ketone monomer has the formula: 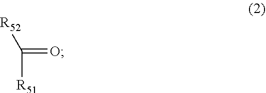
(iv) the aromatic monomer has the formula: 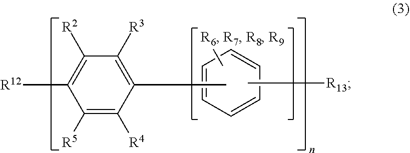
(v) the trifluoromethyl ketone monomer has the formula: 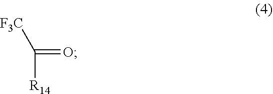
and
(vi) the diketone monomer has the formula: 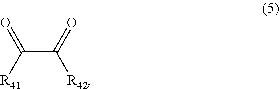
wherein:
A⁻is an anion;
n is 0, 1, 2 or 3;
R₁, R₂, R₃, R₄, R₅, R₆, R₇, R₈, R₉, R₁₂, R₁₃, R₁₅, R₁₆, R₁₇, R₁₈, R₁₉, R₃₁, R₃₂, R₃₃, R₃₄, R₃₅, R₃₆, R₃₇, R₃₈, R₃₉, R₅₂, R₆₁ and R₆₂ are each independently hydrogen, halide, alkyl, alkenyl, alkynyl or aryl, and the alkyl, alkenyl, alkynyl or aryl are optionally substituted with halide, and wherein R₃ and R₆ are optionally linked to form a five membered ring optionally substituted with halide or alkyl;
each R₁₄ is independently alkyl, alkenyl, alkynyl, or 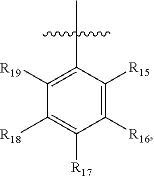
and the alkyl, alkenyl, or alkynyl are optionally substituted with fluoride;
R₄₁ and R₄₂ are each independently alkyl, alkenyl, alkynyl, amine or aryl, and the alkyl, alkenyl, alkynyl, amine or aryl are optionally substituted with halide or alkyl, and wherein R₄₁ and R₄₂ are optionally linked to form a five or six membered ring or a polycycle;
each R₅₁ is independently 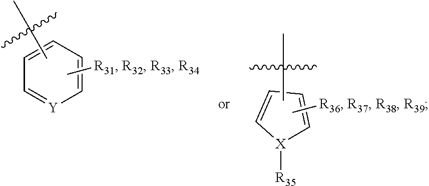
X is N, S or O; and
Y is C or N.

5.-22. (canceled)

23. A polymer comprising a reaction product of a base and the polymer of claim 2.

24. A polymer comprising a reaction product of an alkylating agent and the polymer of claim 23.

25. A polymer comprising a reaction product of an ion exchange solution and the polymer of claim 1.

26. A polymer comprising a reaction product of a base and the polymer of claim 23.

27. A polymer comprising a second reaction product of a second polymerization mixture comprising: a base, an alkylating reagent, and an intermediate polymer; wherein: the intermediate polymer comprises a first reaction product of a first polymerization mixture comprising the monomers of claim 2.

28.-42. (canceled)

43. A method of making an anion exchange polymer of claim 2, the method comprising:
reacting the quaternized piperidone monomer with the aromatic monomer, the optional ketone monomer, the optional trifluoromethyl ketone and the optional diketone monomer in the presence of an organic solvent and a polymerization catalyst to form a piperidinium-functionalized polymer; and
exchanging anions of the piperidinium-functionalized polymer with halide, hydroxide, bicarbonate, or carbonate ions or a combination thereof to form the anion exchange polymer.

44. A method of making an anion exchange polymer of claim 2, the method comprising:
reacting the piperidone monomer with the aromatic monomer, the optional ketone monomer, the optional trifluoromethyl ketone and the optional diketone monomer in the presence of an organic solvent and a polymerization catalyst to form an acidified intermediate polymer;
reacting the acidified intermediate polymer with a base to form a piperidine-functionalized polymer;
alkylating the piperidine-functionalized intermediate polymer in the presence of an organic solvent to form a piperidinium-functionalized intermediate polymer; and
reacting the piperidinium-functionalized intermediate polymer with halide, hydroxide, bicarbonate, or carbonate ions or a combination thereof to form the anion exchange polymer.

45. A method of making an anion exchange polymer membrane comprising the polymer of claim 2, the method comprising:
reacting the piperidone monomer with the aromatic monomer, the optional ketone monomer, the optional trifluoromethyl ketone and the optional diketone monomer in the presence of an organic solvent and a polymerization catalyst to form an acidified intermediate polymer;
reacting the acidified intermediate polymer with a base to form a neutral piperidine-functionalized polymer;
reacting the neutral piperidine-functionalized polymer with an alkylating agent to form a piperidinium-functionalized polymer;
exchanging anions of the piperidinium-functionalized polymer with hydroxide, bicarbonate, or carbonate ions or a combination thereof to form the anion exchange polymer;
dissolving the anion exchange polymer in a solvent to form a polymer suspension or solution; and
casting the polymer suspension or solution to form the anion exchange polymer membrane.

46. A method of making a crosslinked anion exchange polymer comprising the anion exchange polymer of claim 2, the method comprising:
reacting the piperidone monomer with the aromatic monomer, the optional ketone monomer, the optional trifluoromethyl ketone and the optional diketone monomer in the presence of an organic solvent and a polymerization catalyst to form an acidified polymer;
reacting the acidified polymer with a base to form a neutral piperidine-functionalized polymer;
partially quaternizing the neutral piperidine-functionalized polymer with an alkylating agent to form a partially quaternized piperidinium-functionalized polymer having piperidine groups available for crosslinking;
reacting the partially quaternized piperidinium-functionalized polymer with a crosslinking reagent to form a crosslinked polymer;
exchanging anions of the crosslinked polymer with halide, hydroxide, bicarbonate, or carbonate ions or a combination thereof to form the crosslinked anion exchange polymer; and
optionally reacting the crosslinked anion exchange polymer with trimethyl amine to quaternize partially reacted crosslinking reagent.

47. A method of making a crosslinked anion exchange polymer comprising the anion exchange polymer of claim 2, the method comprising:
reacting the piperidone monomer with the aromatic monomer, the optional ketone monomer, the optional trifluoromethyl ketone and the optional diketone monomer in the presence of an organic solvent and a polymerization catalyst to form an acidified polymer;
reacting the acidified polymer with a base to form a neutral piperidine- functionalized polymer;
partially quaternizing the neutral piperidine-functionalized polymer with a crosslinking regent to form a crosslinked polymer;
reacting the crosslinked polymer with an alkylating agent to form a fully quaternized crosslinked polymer; and
exchanging anions of the polymer with halide, hydroxide, bicarbonate, or carbonate ions or a combination thereof to form the crosslinked anion exchange polymer.

48. A method of making a crosslinked polymer membrane or a crosslinked anion exchange polymer membrane comprising the anion exchange polymer of claim 2, the method comprising:
reacting the piperidone monomer with the aromatic monomer, the optional ketone monomer, the optional trifluoromethyl ketone and the optional diketone monomer in the presence of an organic solvent and a polymerization catalyst to form an acidified polymer;
reacting the acidified polymer with a base to form a neutral piperidine-functionalized polymer;
reacting the neutral piperidine-functionalized polymer with an alkylating agent to form a piperidinium-functionalized polymer while leaving part of the neutral piperidine intact for crosslinking;
optionally exchanging anions of the piperidinium-functionalized polymer with hydroxide, bicarbonate, or carbonate ions or a combination thereof to form an anion exchange polymer membrane;
dissolving the piperidinium-functionalized polymer or the anion exchange polymer membrane in a solvent to form a polymer suspension or solution;
adding a crosslinking reagent to the polymer suspension or solution and casting to form the crosslinked polymer membrane or the crosslinked anion exchange polymer membrane;
optionally reacting the crosslinked polymer membrane or the crosslinked anion exchange polymer membrane with trimethyl amine to quaternize partially reacted crosslinking reagent; and
optionally exchanging anions of the crosslinked polymer membrane or the crosslinked anion exchange polymer membrane with hydroxide, bicarbonate, or carbonate ions or a combination thereof.

49.-53. (canceled)

54. An anion exchange membrane configured and sized to be suitable for use in a fuel cell, electrolyzer, electrodialyzer, solar hydrogen generator, flow battery, desalinator, sensor, demineralization of water, ultra-pure water production, wastewater treatment, ion exchanger, or CO2 separator, and comprising the polymer of of claim 1.

55. An anion exchange membrane fuel cell, electrolyzer, electrodialyzer, solar hydrogen generator, flow battery, desalinator, sensor, demineralization of water, ultra-pure water production, wastewater treatment, ion exchanger, or CO2 separator comprising the polymer of claim 1.

56. A reinforced ion exchange membrane or electrolyte membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO2 separator, the reinforced membrane comprising a porous substrate impregnated with the polymer of claim 1.

57.-58. (canceled)
